(19) United States
(12) Patent Application Publication
(10) Pub. No.: US 2001/0049635 A1
(43) Pub. Date: Dec. 6, 2001

(54) User interface and associated data source

(75) Inventor: Jeff B. Chung, Salt Lake City, UT (US)

Correspondence Address: Charles L. Roberts, WORKMAN, NYDEGGER & SEELEY, 1000 Eagle Gate Tower, 60 East South Temple, Salt Lake City, UT, 84111, US

(73) Assignee: PEOPLEPUBLISH, INC.

(21) Appl. No.: 09/821,394

(22) Filed: Mar. 29, 2001

Related U.S. Application Data
(60) Provisional application No. 60/185,983, filed on Mar. 1, 2000.

(51) Int. Cl. G06F 17/60

(52) U.S. Cl. 705/26

(57) ABSTRACT

The present invention includes an interactive user interface in the form of a banner advertisement having various data form elements and action form elements for receiving input and data provided by a user. The advertisement additionally includes commercial information relating to the product or service that is the primary subject of the advertisement. The advertisement is embedded in one or more web pages of a website so that when such web page is displayed, the advertisement is presented to a user. Upon encountering the advertisement, the user may enter ordering data, preferably by way of a wallet file created by a wallet program and resident on the client computer, into data form elements of the advertisement, thereby defining an order. The wallet program and the wallet file permit the user to populate all of the data form elements of the advertisement simultaneously. Upon definition of the order, the user may select an action form element of the advertisement so as to cause the order to be transmitted to a server The server then processes and ships an order conforming to the input provided by the user. As a result, the user is able to quickly and easily order specific products and services over a global computer network without having to search the global computer network for such products and services and without having to access and display the website of the vendor whose product or service is the subject of the advertisement employed by the user.

### CLAIM FOR PRIORITY

This application is a continuation-in-part of co-pending U.S. patent application Ser. No. 60/185,983, entitled Ergonomic Reader Software With Integrated Advertising Capability, filed Mar. 1, 2000, and incorporated herein in its entirety by this reference (the “'983 Application”).

### BACKGROUND OF THE INVENTION

1. The Field of the Invention

The present invention relates generally to communication between a client computer and a server. More particularly, embodiments of the present invention relate to an improved user interface in the form of a banner advertisement, and an associated wallet program, that cooperate to facilitate ready and efficient communication between the client computer and server by allowing a user to communicate with the server, so as to cause the server to perform one or more actions consistent with user input, without requiring the user to access particular web pages with which the user interface may be associated.

2. The Prior State of the Art

The ubiquitous nature of the global computer network commonly referred to as the ‘internet,’ and the rapid expansion of the types and numbers of internet locations or ‘web sites,’ and their constituent web pages, accessible via the internet have combined to place a virtual mine of information at the disposal of anyone possessing a computer and a modem. Additionally, the development of web ‘browser’ programs which enable a user to navigate the internet and individual web pages has also been a major contributor to the increased usage of computers and the internet. Generally, a web browser refers to a computer software program that operates in conjunction with a computer display and a communication device, such as a modem, in such a way as to permit a user to electronically access and view web pages located on servers connected to the internet. Thus, anyone with a computer, modem, and browser program can access information at literally millions of different web pages on servers located around the world.

Commercial enterprises have been quick to recognize that the expansive reach of the internet gives the internet vast potential as a channel of trade. The advantages of the internet as a trade channel are numerous. For example, the fact that a product is not locally available to a consumer presents no impediment to the procurement of the product by the consumer. Rather, a consumer can simply search the internet, using one or more of the so-called search engines, and find a website through which the consumer can purchase the desired product or service.

To provide a more specific example, a consumer in Utah wishing to purchase cane syrup may find it difficult, if not impossible, to locate such a product locally. To further complicate matters, such a consumer may not even know where to look to find such a product. However, through the use of ‘search engine’ programs, the consumer can comb through the millions of internet web sites and find a web site with the desired product. In the aforementioned example then, the consumer would likely find one or more manufacturers, in a state such as Alabama, that stocks and ships cane syrup. In this way, the functionality provided by the internet and related software has enabled the consumer to identify a vendor for the goods in which he is interested.

Further, most commercial websites on the internet are not limited solely to enumerating the various products carried by the owner of the web site. Rather, such commercial sites also typically permit a consumer to order and pay for such products, by way of a computer located at the workplace or residence of the consumer, and have the products shipped to any location(s) specified by the consumer. Thus, due to the global reach of the internet, the hypothetical vendor in Alabama has been able to consummate a transaction that, absent the functionality provided by the internet and related software, likely would not have occurred.

Indeed, prior to the development of such commercial websites, the Utah consumer would probably not have had specific knowledge of the existence of the Alabama vendor and would have been compelled to engage in the laborious task of looking through phone directories for various states in an effort to find a vendor that produced the product in which the consumer was interested. In most cases, it is unlikely that a consumer would engage in such efforts. Even if the consumer had found such a vendor in another state, various factors, such as long distance phone charges, and the inability to view the product, may have discouraged the consumer from attempting to purchase the product.

Not only has the internet allowed vendors to reach previously untapped markets, but, in most cases, the vendor has been able to do so relatively cheaply. In particular, a simple web site that lists various products and prices and which provides for on-line ordering, is relatively inexpensive to set up and maintain. Thus, with a relatively small investment, a vendor is able to obtain global exposure for its products and/or services. Consequently, numerous vendors have adopted website marketing and sales as an important component of their overall business plan.

Consumers have been equally enthusiastic about the development of commercial web sites As suggested in the earlier hypothetical, consumers now have access to an endless variety of products available from locations throughout the world. Previously, most such products were either simply unavailable to consumers, or were so difficult to obtain through conventional methods as to be practically unavailable.

While both vendors and consumers have enthusiastically embraced internet-based commerce, various problems exist that act to compromise the ability of the consumer to quickly and easily order and obtain various goods and services by way of the internet. Many such problems relate to the way in which vendors advertise, and make available, their products and services. A closely related problem concerns the creation, storage, and handling of the consumer-specific information that is typically required to consummate the sale of goods and services in the context of global computer networks such as the internet.

Turning first to vendor advertisements and related matters, vendors typically present information regarding their products or services to potential buyers over the internet in two primary ways. The first vehicle used to present such information is simply through the website of the vendor. Such vendor websites generally include lists of the products available from that vendor, the prices of those products and various other details regarding the products. These web sites also generally include some type of search functionality so that a potential consumer can search the vendor web site for the desired product. Finally, vendor websites typically include a vehicle for collecting information regarding the items that the consumer has indicated he wished to purchase, as well as ordering and payment features.

To use the vendor website, a consumer interested in a particular product accesses the vendor website and searches for products of interest. The consumer then electronically deposits information regarding those products in a so-called ‘shopping cart,’ or the like, and initiates the ordering process. During the ordering process, the consumer will be required to provide information such as his name, address, telephone number, email address, credit card information and any other such information as the vendor may require. Note that, as suggested above, various problems associated with this aspect of internet-based commerce will be discussed below in greater detail. After having provided the requisite ordering information, the consumer then transmits the order to the vendor for processing.

Once the order has been transmitted by the consumer and received by the vendor, the vendor then processes the order and ships the ordered products to the consumer. In some cases, the vendor may send a confirmatory email to the consumer verifying information such as the goods ordered and the shipping status of those goods. Notwithstanding the enthusiasm with which they have been employed and embraced however, the product advertising and purchasing schemes typically embodied by vendor websites suffer from a number of significant shortcomings.

One of such shortcomings concerns the manner in which the product information is provided to the potential consumer. In particular, even if the consumer knows precisely the product and, for example, the model number of the desired product, the consumer is nevertheless compelled to visit the website of the vendor and search the website in an attempt to find that particular product. However, the sensitivity of such search functions to the syntax used by the consumer can impair the ability of the consumer to find, and thus obtain, the desired product. For example, some search functions will not produce a result unless the consumer has spelled the name of the product correctly. Thus, notwithstanding the fact that the vendor offers the desired product for sale, if the consumer does not completely or properly identify the product in the search, the website may return a message indicating that the vendor has no such product. Even if the consumer succeeds in finding the desired product, he must then go through the time-consuming process of submitting all of the information necessary to order, pay for, and ship the product.

The situation is further aggravated when the consumer does not know which particular vendor(s) sell the desired product. In such an instance, the consumer is typically compelled to use a search engine to search the internet in an attempt to find vendors who carry that product. Such searches may be time-consuming, frustrating, and in many cases may prove ineffective in identifying a vendor who stocks and sells the product in which the consumer is interested. For example, such search engines often suffer from some of the same shortcomings as the search functions embodied within individual websites, so that unless the consumer provides precise information regarding the desired product, the search engine may not find that product. Furthermore, even if the consumer has employed the proper syntax and the like, such search engines typically are unable to distinguish between commercial and non-commercial websites, so the consumer may be compelled to visit several websites identified in the search before finding the vendor website of interest to that consumer.

As suggested above, vendors typically employ at least one other vehicle for providing information to consumers regarding various products and services. In particular, many vendors employ ‘banner advertisements’ located on websites other than their own, to present product and/or service information to potential consumers. In general, a banner advertisement refers to an advertisement that includes a graphical component, or ‘banner,’ suitable for display on a client computer. Typically, the banner presents a small amount of information or advertising directed toward getting the attention of the consumer, and also includes an embedded hyperlink. When the user “clicks” on the banner advertisement with an input device, such as a mouse, the browser software on the client computer accesses and displays the web page associated with the embedded hyperlink. In this way, the consumer is able to access, at least indirectly, fuller and more detailed information regarding the item or service that is the subject of the banner advertisement. As discussed below however, known banner advertisements and related advertising and sales methods suffer from shortcomings that serve to compromise, complicate, and otherwise impair the process of ordering products and services through commercial websites.

In general, one shortcoming of vehicles such as banner advertisements relates to the lack of information provided by such banner advertisements. Specifically, typical banner advertisements contain only a small amount of information regarding a particular product or service. This is due at least in part to the fact that banner advertisements are typically limited to a relatively small amount of space on the web page with which they are displayed. Thus, typical banner advertisements do little more than act as road signs, directing the consumer to a particular website where an order can be defined and placed. The general inability of known banner advertisements to present complete ordering information and functionality is a significant limitation, both when considered from the perspective of the vendor, and when considered from the perspective of the consumer.

As suggested above, the interests of vendors are not well served by typical banner advertisements. More specifically, because such banner advertisements initially present to the consumer only a limited amount of information and functionality, the vendor is unable to present his entire sales message, and corresponding ordering functionality, to the consumer within the context of a single banner advertisement. Thus, in order to obtain more complete information, such as graphical representations of the featured product/service, vendor information, price, and shipping costs, and to place an order, the consumer is typically compelled to “click through” to the web site with which the banner advertisement is associated.

In response to the foregoing limitations concerning the limited functionality and information presented by typical banner advertisements, vendors have attempted to devise and present banner advertisements sufficiently compelling that they not only catch the attention of a consumer but also encourage a consumer to click through to the web site of the vendor, access the additional product/service information, and, ultimately, make a purchase. However, such efforts have proven largely ineffective. In particular, it is well known that only a small percentage of banner advertisements are ever “clicked,” or selected, by a consumer. In fact, some sources in the industry have estimated that, currently, only about one quarter of one percent (0.25%) of banner advertisements are clicked by consumers. Thus, known banner advertisements are frequently ineffective in generating sales because consumers typically do not click through to the associated web site through which a sale of the advertised product or service must be consummated.

At least one reason that consumers rarely click banner advertisements concerns the fact, noted earlier, that typical banner advertisements generally do not contemporaneously provide the consumer with all of the information and functionality necessary to consummate a sale of the product or service with which the banner advertisement is associated.

By way of example, in the event that the consumer is interested in purchasing the product or desires additional information concerning the product, the consumer is compelled to select the hyperlink embedded in the banner advertisement, so as to be directed to the website through which the product is made available. Upon accessing that website, the consumer must then engage in the often time-consuming and frustrating product search and order process previously described. However, many consumers are not inclined to spend the time required to take all of these additional steps. Thus, the failure of many banner advertisements to provide complete product/service information and ordering functionality may have a deterrent effect with respect to prospective purchases by consumers.

In general then, many known banner advertisement configurations act not only to impair the effective presentation and marketing of the products and services of the vendor with whom the banner advertisement is associated, but also act to discourage prospective customers from placing orders for the products and/or services of the vendor. Known banner advertisements suffer from a variety of other shortcomings as well.

In particular, another problem associated with typical banner advertisements concerns the sequence of events that occurs after the consumer has selected the hyperlink embedded in the banner advertisement. For example, a consumer browsing a particular website may encounter a banner advertisement at that website and desire to order the product indicated on the banner advertisement. However, when the consumer selects the banner advertisement, the banner advertisement, acting through the browser program, directs the consumer to the website associated with the banner and, as a result, the website that the consumer was browsing is no longer displayed. That is, when selected by the consumer, the banner advertisement interrupts the consumer and, acting through the browser program, clears the displayed web page and then causes the web page associated with the hyperlink selected by the consumer to be displayed on the client computer. In other instances, the banner advertisement may cause another window to be opened. In either event, such a result is a source of some annoyance and frustration, particularly in those cases where the consumer wishes to order an item but does not wish to clear the displayed web page.

Yet another problem concerns the context in which known banner advertisements are typically employed. In particular, and as suggested above, known banner advertisements are generally limited to the context of web pages. However, increasingly popular media such as electronic texts and books, or so-called ‘e-books,’ and the like, typically do not include advertising. In contrast, various types of advertisements are staple items in print media such as newspapers, magazines, periodicals and some books. As the market for electronic texts such as e-books and e-magazines grows, vendors will likely wish to avail themselves of the opportunity to present advertisements to consumers by way of such media.

Specifically, the capability to integrate advertising, for example, in conjunction with the display of electronic texts is of considerable commercial interest to both the electronic book sellers and vendors for a number of reasons. For example, the use of advertising in the context of electronic media allows vendors to gain access to users and consumers of such electronic media. Further, such advertising represents a potentially important source of revenue to electronic book sellers who are willing to include vendor advertisements in products such as reader software and/or electronic media such as e-books. Thus, the lack of adequate advertising/ordering vehicles for use in conjunction with such media represents a significant shortcoming in the art.

Yet other shortcomings with known banner advertisements concern the manner in which such banner advertisements are presented to prospective consumers. For example, many known banner advertisements include various dynamic elements such as color, shape, sound, and position on the web page, that vary over a given time interval so as to present visual, audio, or other stimuli to the consumer. However, while the eyes of a consumer may by such banner advertisements often tends primarily to distract and annoy prospective consumers. The fact that the consumer cannot control the display of the banner advertisement in any way further aggravates the situation.

By way of example, in a case where a consumer is reading an electronic text, or alternatively, an article posted on a web page, a continuously flashing banner advertisement often serves not to entice the consumer to make a purchase, but rather to distract and irritate the consumer. Such a result does little to enhance vendor sales.

On the other hand, banner advertisements that do not vary with respect to a given time interval are problematic as well. In addition to being too small to incorporate the information and functionality necessary to facilitate definition and placement of a product/service order, many banner advertisements are configured so that they do not change, or are not replaced, unless the entire web page with which they are associated changes, or is “reloaded” by the browser program. Such banner ads are undesirable at least because they compromise the efficiency with which the space allocated to an advertiser is used.

The limitations of typical banner advertisements are well known and various attempts have been made to develop banner advertisements which resolve at least some of the problems known in the art. However, for at least the reasons enumerated herein, such attempts have failed to adequately or completely resolve such problems.

At least one known banner advertisement possesses interactivity functionality in the sense that it claims to permit the viewer of the banner advertisement to interact with the banner advertisement itself For example, banner advertisements are known that include a primitive video game capability. In such banner advertisements, the consumer is able to play a videogame that is part of the banner advertisement itself Thus, these types of banner advertisements are interactive only in the general sense that they are capable of accepting some limited consumer input, generating a response to such input, and presenting such response to the user.

While banner advertisements of the type outlined above represent some improvement over those banner advertisements, discussed elsewhere herein, possessing simply a sign post functionality that serves solely to direct a user to a predefined website, such known interactive banner advertisements lack, among other things, the capability to transmit or convey specific consumer input to another website or server in such a way as to cause the server to perform actions corresponding to the consumer input. Rather, the interactivity of such banner advertisements is limited to a ‘local’ environment in the sense that the interaction takes place only between the consumer and the advertisement itself, and the banner advertisement does not serve to facilitate efficient and effective interaction between the client computer and a server or other remote site.

Yet other interactive banner advertisements include pull-down menus which a consumer can then use to navigate to other internet websites. As with conventional banner advertisements however, such limited functionality fails to facilitate or simplify product ordering by the consumer. In particular, after having selected a web site from the pull-down menu, the consumer is nevertheless compelled to visit the associated web site and engage in the product searching and ordering process previously described. Thus, while this type of banner advertisement is marginally responsive to consumer input, such a banner advertisement is little more than a signpost serving to direct a consumer to any of a number of websites identified in the pull down menu. Further, such a banner does little, if anything, to simplify the ordering of products by way of the internet, to facilitate efficient and effective interaction between the client computer of the consumer and a remote site such as a server, or permit the user to direct, by way of the banner advertisement, the actions of a server.

Still other interactive banner advertisements include the capability to provide the advertiser and/or website administrator various data regarding such matters as how many consumers view the banner advertisement, how long the banner advertisement was displayed and the actions, if any, that the consumer(s) took with respect to the banner advertisement. While such information may be helpful from a marketing viewpoint, it nevertheless does little, if anything, to facilitate or simplify the process by which the consumer orders products over the internet. Furthermore, such functionality is not directed towards interactivity with the potential consumer, but rather with the advertiser that originated the advertisement.

As suggested earlier, the problems in the art are not limited solely to shortcomings with advertising vehicles and the like. Specifically, other problems concern the creation, storage, and handling of the consumer-specific information that is typically required to consummate the sale of goods and services in the context of global computer networks such as the internet.

By way of background, a consumer who wishes to order a product or service by way of a vendor website is required to enter certain requisite consumer information. Typically, the information required of such a consumer includes the name, address, telephone number, email address, credit card number, and credit card expiration date of the consumer. Generally, the vendor website has an ordering web page with appropriate blank spaces or the like in which the consumer must enter, by way of a keyboard or analogous device, the requisite consumer information. The consumer then completes the order by selecting an “ORDER” button or the like which causes the consumer information and product information to be transmitted to the vendor web server.

Typically, the consumer information is stored at the vendor web server, and a computer-specific “cookie” transmitted from the vendor web server and stored at the computer of the consumer so that the next time the consumer accesses the vendor website with that computer, the computer will be recognized by the vendor web server. Upon such recognition, the web server is then able to correlate that computer with the consumer information previously stored at the web server. In this way, the consumer is spared the trouble of re-entering the consumer information each time it is desired to place an order at the vendor website. Notwithstanding the measure of convenience afforded by the aforementioned processes, at least some aspects of such processes have proven problematic.

One such problem concerns the lack of flexibility of such known processes. For example, such processes are not well suited for use in situations where multiple users may wish to order products and services by way of a common computer. In such a case, the cookie sent by the vendor web server corresponds only to the consumer information most recently provided from the computer. Further, because the consumer information is not stored locally at the consumer computer, but rather at the various, remote, web servers to which it has been submitted, it is inconvenient for another consumer to make changes to the consumer information.

Thus, if another consumer, having different consumer information, wishes to place an order from the same computer, that consumer is typically compelled, at a minimum, to access the vendor website and modify the previously entered consumer information to reflect the aspects thereof that are unique to him. Such modification is typically accomplished by hand entering the new consumer information. In some cases, the consumer may be compelled to enter an entire set of consumer information to overwrite the previously entered set. Note that the same implications arise where a consumer, even if the most recent to enter consumer information, wishes to change his own consumer information.

Another problem related to the lack of flexibility inherent in known internet-based ordering processes concerns the common situation where a user desires to order, by way of a single computer, products or services from multiple websites. As discussed above, known ordering processes provide some measure of convenience in that once a consumer has entered consumer information for a particular website, that consumer may in some instances be able to make subsequent purchases from that website without having to enter any additional information.

However, the aforementioned is true only in the case of that particular website. In the event a consumer wishes to order products and services from additional websites, the consumer is compelled to hand enter consumer information for every new website from which it is desired to make such orders. This is a time-consuming process and, by virtue of the hand entry aspect, a process that is inevitably prone to data entry errors which require correction, and which accordingly contribute to further delay. This problem is further aggravated where multiple users use the same computer to order goods and services from various vendor websites.

Finally, another problem relates to the security of the consumer information once it is stored at the vendor web server. In particular, as noted above, the cookie sent by the vendor web server corresponds to a particular computer, but not to a particular consumer. Thus, once consumer information has been transmitted to the vendor web server, it would be a relatively simple matter for an unauthorized person to gain access to the computer from which the consumer information was sent, and then, using the consumer information previously submitted, place unauthorized orders from the vendor website.

In view of the foregoing discussion, what is needed is an improved user interface, for use in a client-server environment, that accepts user input at a client computer and employs that user input to at least indirectly cause a remote server, with which the client computer communicates, to perform one or more actions consistent with the user input. Further, embodiments of the present invention include a wallet program for creating and formatting one or more user-specific wallet files that reside at a client computer and which facilitate ready and reliable entry of a predetermined block of data in both the user interface and various known user interfaces. Additionally, embodiments of the user interface should be suitable for use as, among other things, advertisements in the context of media such as electronic texts and web pages. Finally, embodiments of the user interface should permit the user to interact with the remote server independently of any web pages associated with the user interface.

### SUMMARY OF THE INVENTION

The present invention has been developed in response to the current state of the art, and in particular, in response to these and other problems and needs that have not been fully or completely solved by currently available user interfaces. Briefly summarized, embodiments of the present invention provide a wallet program and an improved user interface which, both individually and collectively, facilitate effective and efficient communication between one or more client computers and a server.

Embodiments of the present invention are particularly suitable for use as banner advertisements in the context of electronic media such as e-books and web pages. However, it will be appreciated that embodiments of the present invention may be employed in any client-server environment where it is desired to allow a user, by way of a client computer, to effectively and efficiently communicate with a server, so as to cause the server to perform one or more actions consistent with input supplied by the user.

One embodiment of the present invention includes a wallet program and corresponding wallet files resident on a client computer, and a banner advertisement displayed on a web page, and linked to a remote server. Preferably the banner advertisement includes graphical, and/or other, media which presents information regarding a particular product or service. Additionally, the banner advertisement includes data form elements and action form elements configured to receive user input provided by way of an input device such as a mouse or keyboard. Preferably, at least one of the wallet files includes a predetermined block of consumer information that is compatible with the data form elements of the banner advertisement.

In operation, the banner advertisement is displayed on one or more web pages so that a consumer viewing such web pages will be presented with the banner advertisement. If the user decides to order the product or service indicated on the banner advertisement, the user accesses the wallet program, preferably by way of a shortcut displayed on the user desktop, and selects a wallet file containing the consumer information, or consumer data, which is desired to be entered into the banner advertisement. Once selected by the user, the consumer data is then used to automatically populate corresponding data form elements provided in the banner advertisement. Optionally, the banner advertisement may also include data form elements that permit the consumer to specify various product features such as color, size, material, and the like.

Based upon the data received by the data form elements, the banner advertisement at least indirectly defines a corresponding product order. The user then selects one or more action form elements that correspond to a desired action. Preferably, at least one of such action form elements comprises an “ORDER” action form element or the like so that, when selected by the consumer, the ORDER action form element causes the product order to be transmitted directly to the server with which the banner is linked, for processing. In response to receipt of the order, the server than transmits an email to the email address identified by the consumer, confirming the goods order and providing any other relevant feedback.

Such functionality thus permits a consumer to, among other things, quickly and easily order a desired product or service without the necessity of accessing a vendor website or engaging in time-consuming web site or internet searches. Furthermore, the vendor may realize a material increase in sales volume and revenue as a result of the ease with which his products can be identified, ordered, and obtained by consumers.

These and other features and advantages of the present invention will become more fully apparent from the following description and appended claims, or may be learned by the practice of the invention as set forth hereinafter.

### BRIEF DESCRIPTION OF THE DRAWINGS

In order to more fully understand the manner in which the above-recited and other advantages and objects of the invention are obtained, a more particular description of the invention will be rendered by reference to specific embodiments thereof which are illustrated in the appended drawings. Understanding that these drawings depict only typical embodiments of the invention, and are not therefore to be considered to be limiting of its scope, the invention and its presently understood best mode for making and using the same will be described and explained with additional specificity and detail through the use of the accompanying drawings in which:

FIG. 1 illustrates an exemplary system that provides a suitable operating environment for the present invention;

FIG. 2A illustrates embodiments of user interface and wallet program configurations in accordance with the teachings of the present invention;

FIG. 2B depicts various additional details of an embodiment of a user interface in accordance with the teachings of the present invention, and also indicates the relationship between an embodiment of the wallet program and the user interface;

FIG. 2C depicts an embodiment of a process for employment of the respective embodiments of the user interface and the wallet program indicated in FIGS. 2A and 2B;

FIG. 3A illustrates a configuration wherein the user interface and wallet program are employed in the context of a web page displayed on a client computer;

FIG. 3B depicts various additional details of embodiments of a user interface and a wallet program and related wallet files, employed in the context of a web page;

FIG. 3C depicts an embodiment of a process for utilizing the wallet program; wallet files and the embodiment of the user interface indicated in FIGS. 3A and 3B;

FIG. 4A illustrates a configuration wherein the user interface, wallet program and wallet files are employed in the context of electronic media displayed on a client computer;

FIG. 4B depicts various details of embodiments of a user interface, wallet program, and wallet files employed in the context of electronic media;

FIG. 4C depicts an embodiment of a process for utilizing the embodiments of the user interface and wallet program indicated in FIG. 4A and 4B;

FIG. 5A illustrates a configuration wherein the user interface and wallet program are employed in the context of a personal shopping service;

FIG. 5B depicts various details of embodiment of a user interface and wallet program employed in the context of a personal shopping service; and

FIG. 5C depicts an embodiment of a process for employment of the embodiments of the user interface and wallet program indicated in FIG. 5A and 5B.

### DETAILED DESCRIPTION OF EMBODIMENTS OF THE INVENTION

Reference will now be made to figures wherein like structures will be provided with like reference designations. It is to be understood that the drawings are diagrammatic and schematic representations of presently preferred embodiments of the invention, and are not to be construed as limiting the present invention.

The present invention extends to both systems and methods for facilitating effective and efficient communication between one or more client computers and a server, without relying on a web page or web site to facilitate such communication. In particular, a user interface is created that is linked to a server and uploaded to a client computer when a web page or other electronic media, where the user interface is presented, is displayed at the client computer. The user interface includes various form elements which are configured to receive input from the user, by way of a user input device in operative communication with the client computer Based upon the input received, the user interface transmits information and/or instructions to the server so as to cause the server to perform one or more actions corresponding to the input received by the user interface.

Embodiments of the present invention may comprise a special purpose or general purpose computer including various computer hardware, as discussed in greater detail below. Embodiments within the scope of the present invention also include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, or special purpose processing device to perform a certain function or group of functions.

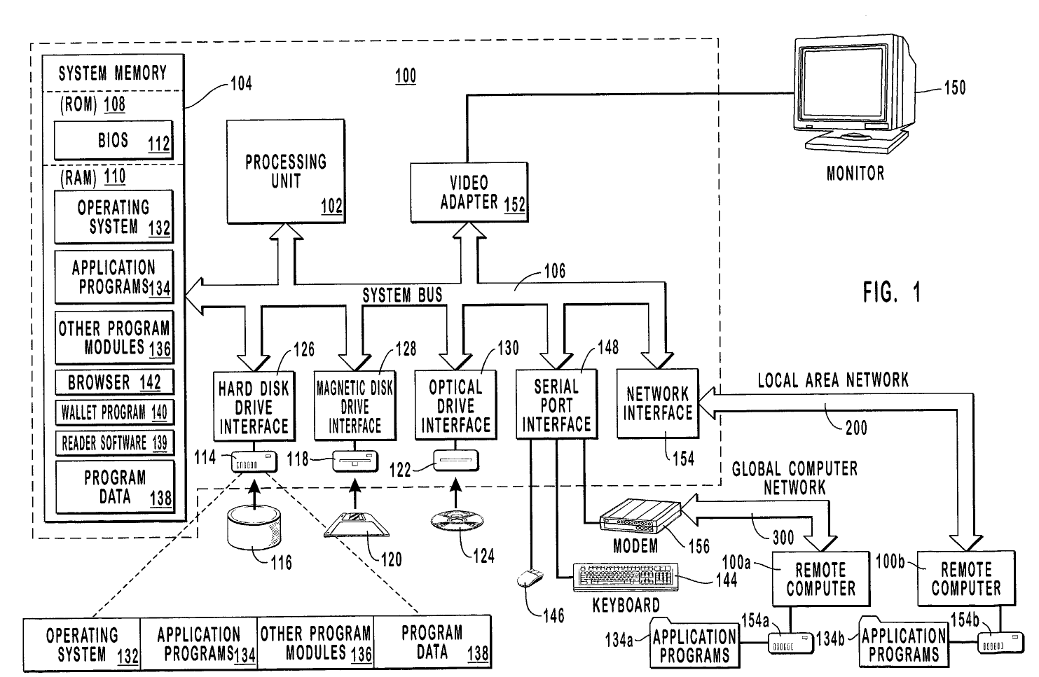

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, content structures, etc. that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a client computer 100, including a processing unit 102, a system memory 104, and a system bus 106 that couples various system components including system memory 104 to processing unit 102. System bus 106 may be any of several types of bus structures including a memory bus or memory controller, a peripheral bus, and a local bus using any of a variety of bus architectures. System memory 104 includes read only memory (ROM) 108 and random access memory (RAM) 110. A basic input/output system (BIOS) 112, containing the basic routines that help transfer information between elements within client computer 100, such as during start-up, may be stored in ROM 108.

Client computer 100 may also include a magnetic hard disk drive 114 for reading from and writing to a magnetic hard disk 116, a magnetic disk drive 118 for reading from or writing to a removable magnetic disk 120, and an optical disk drive 122 for reading from or writing to removable optical disk 124 such as a CD-ROM or other optical media. Magnetic hard disk drive 114, magnetic disk drive 118, and optical disk drive 122 are connected to system bus 106 by a hard disk drive interface 126, a magnetic disk drive interface 128, and an optical disk drive interface 130, respectively. The drives and their associated computer-readable media provide nonvolatile storage of computer-executable instructions, content structures, program modules and other content for client computer 100.

Although the exemplary environment described herein employs a magnetic hard disk 116, a removable magnetic disk 120 and a removable optical disk 124, other types of computer readable media for storing content can be used, including magnetic cassettes, flash memory cards, digital video disks, Bernoulli cartridges, RAMs, ROMs, and the like.

Program code means comprising one or more program modules may be stored on hard disk 116, magnetic disk 120, optical disk 124, ROM 108 or RAM 110, including an operating system 132, one or more application programs 134, other program modules 136, program data 138, reader software 139, wallet program 140, and browser program 142. A user may enter commands and information into computer 100 through keyboard 144, pointing device 146, or other input devices (not shown), such as a microphone, joy stick, game pad, satellite dish, scanner, microphone, or the like. Such input devices will be referred to herein as “input device 145,” with the understanding that input device 145 may include one or more of the input devices disclosed herein, either alone or in such combinations as may be desired and/or necessary. These and other input devices are often connected to processing unit 102 through a serial port interface 148 coupled to system bus 106. Alternatively, the input devices may be connected by other interfaces, such as a parallel port, a game port or a universal serial bus (USB). A monitor 150 or another display device is also connected to system bus 106 via an interface, such as video adapter 152. In addition to monitor 150, personal computers typically include other peripheral output devices (not shown), such as speakers, printers, scanners, and the like.

Client computer 100 preferably operates in a networked environment, also referred to herein as a “client-server” environment, using logical connections to one or more servers, such as servers 100A and 100B. Note that as contemplated herein, a ‘server’ refers to a computer in a network shared by multiple users, and the term ‘server’ may also refer to both the hardware and/or software that performs one or more of the service(s), tasks, operations, and functions disclosed herein. Examples of types of servers contemplated as being within the scope of the present invention include, but are not limited to, web servers, application servers, remote access servers, mail servers, merchant servers, database servers, and the like. Further, servers 100A and 100B may each be another personal computer, a server, a router, a network PC, a peer device or other common network node, and typically includes many or all of the elements described above relative to client computer 100, although only memory storage devices 154A and 154B and their associated application programs 134A and 134B have been illustrated in FIG. 1.

The logical connections depicted in FIG. 1 include a local area network (LAN) 200 and a global computer network 300 that are presented here by way of example and not limitation. Such networking environments are commonplace in office-wide or enterprise-wide computer networks, intranets and the Internet. It will be appreciated that embodiments of the present invention may also be employed in the context of Wide Area Networks (WANs) and other networks that typically cover a wide geographic area such as a state or country.

When used in a LAN networking environment, client computer 100 is connected to LAN 200 through a network interface 154. When used in a global computer network 300 networking environment, client computer 100 may include a modem 156, a wireless link, or other means for establishing communications over global computer network 300. Modem 156, which may be internal or external to client computer 100, is connected to system bus 106 via serial port interface 148. In a networked environment, program modules depicted relative to client computer 100, or portions thereof, may be stored in remote memory storage device(s) 154A and 154B. It will be appreciated that the network connections shown are exemplary and other means of establishing communications over global computer network 300 may be used.

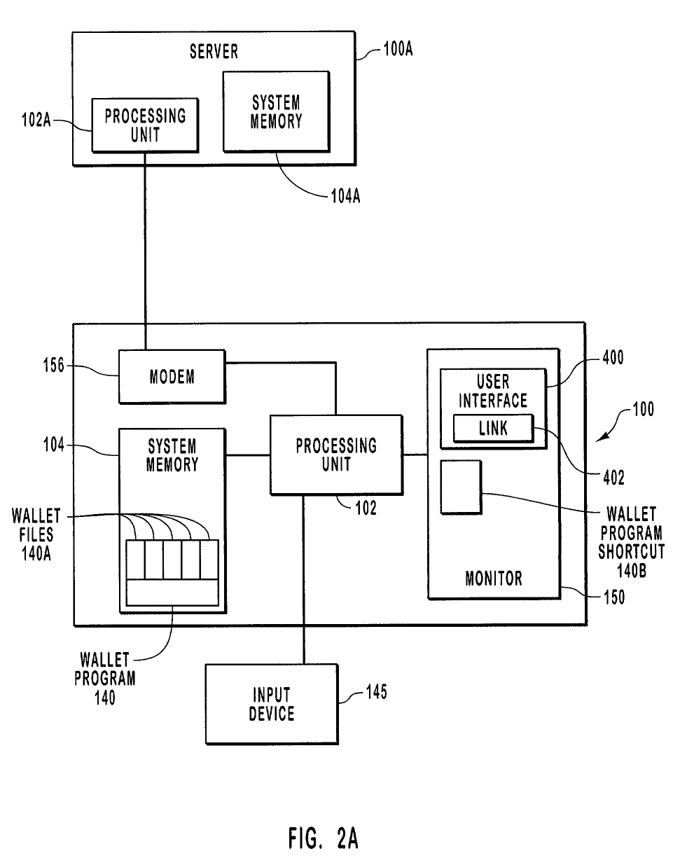

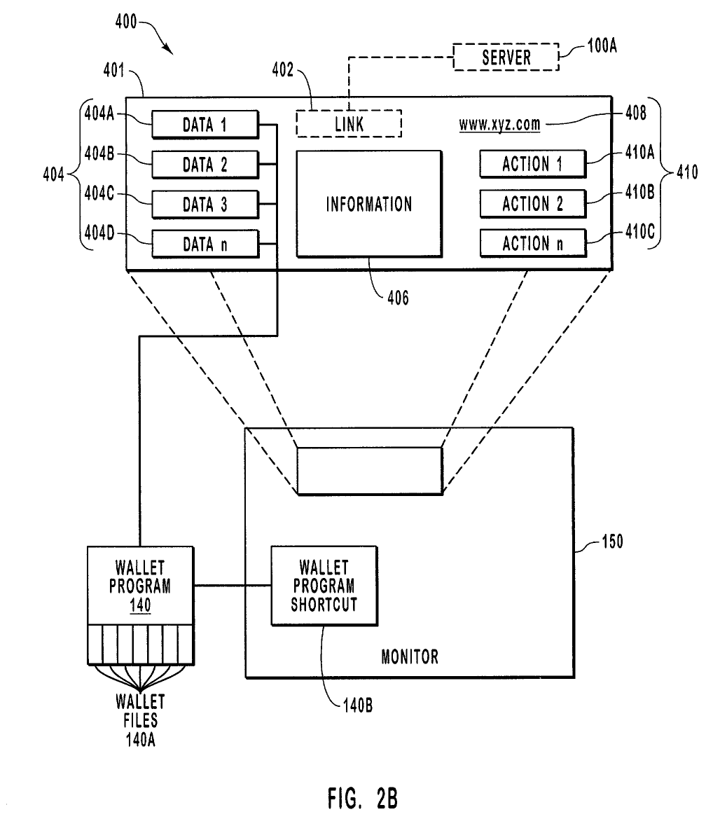

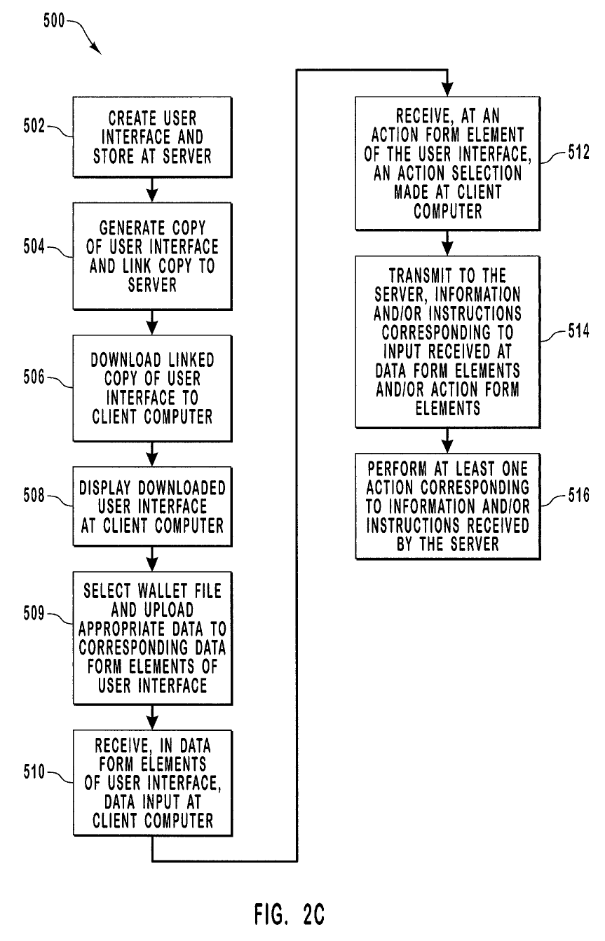

Directing attention now to FIG. 2A, various details are provided regarding an exemplary application of an embodiment of a user interface and wallet program, indicated generally at 400 and 140, respectively, in accordance with the teachings of the present invention. It will be appreciated that, at least with respect to wallet program 140 and wallet files 140A, embodiments of wallet program 140 and wallet files 140A are suitable for use in a variety of other contexts, applications, and data form elements as well, including, but not limited to, web page product/service order forms and the like, such as are typically employed in the context of commercial websites to facilitate definition and transmission of product and service orders.

In general, an exemplary environment for user interface 400 and wallet program 140 includes a client computer 100 having a processing unit 102, input device 145, a monitor 150, and modem 156. Modem 156 of computer 100 facilitates communication between client computer 100 and server 100A. Server 100A includes a processing unit 102A, and system memory 104A for storing one or more user interfaces 400 (discussed in detail below). Note that in an alternative embodiment, user interfaces 400 may be stored at a location other than server 100A. Finally, wallet program 140 and wallet files 140A are stored in system memory 104, and a wallet program shortcut 140B is presented on monitor 150. While more specific details regarding the operation of the systems and devices depicted in FIG. 2A are provided in the context of the discussion of FIG. 2C, a general discussion of various features and elements illustrated in FIG. 2A is useful at this juncture.

As noted above, one or more user interfaces 400 are stored at system memory 104A of server 100A. Such user interfaces 400 may be created by way of software resident on server 100A or may alternatively be created in another location and uploaded or downloaded to system memory 104A of server 100A, as appropriate. In either event, user interfaces 400 are copied at server 100A and the copies are downloaded, according to desired criteria, from server 100A to client computer 100 by way of modem 156 when communication is established between client computer 100 and server 100A. It will be appreciated that variables such as, but not limited to, the timing of the downloading of user interfaces 400, the number of user interfaces 400 downloaded, and the content and functionality of user interfaces 400 downloaded, may be varied as required, either alone or in various combinations, to suit a particular application and/or to achieve one or more desired results. Once downloaded to client computer 100, temporary copies of user interfaces 400 are stored in system memory 104 for selective retrieval.

In accordance with input provided by the user, one or more of the downloaded user interfaces 400 are then retrieved and displayed on monitor 150 of client computer 100. Preferably, wallet program shortcut 140B is displayed on monitor 150 contemporaneously with such user interfaces 400. It will be appreciated that server 100A and/or client computer 100 may be configured to periodically refresh user interfaces 400 presented at client computer 100. Such refreshment may consist of periodic replacement of user interface(s) 400 then currently displayed, or alternatively, may consist simply of modification of one or more constituent portions of one or more user interface(s) 400. Alternatively, a plurality of user interfaces 400 may be stored at client computer 100 so that, for example, after a certain period of time had passed or some other criteria had been met, the currently displayed user interface(s) 400 would then be replaced with other user interfaces stored at client computer 100 The criteria controlling replacement of such user interfaces 400 may be selected as required to suit a particular application and/or to facilitate achievement of one or more desired results.

Generally, input provided to user interface 400 by way of input device 145 at least indirectly causes user interface 400 to generate and transmit instructions, data, and/or the like (hereinafter collectively, “instructions”), corresponding to such user input, to server 100A by way of server communication link 402 and modem 156. Note that server communication link 402 is distinct from hyperlink 408 (discussed below) in that server communication link 402 facilitates communication between client computer 100 and server 100A, whereas hyperlink 408 facilitates display of one or more desired web pages at monitor 150. With continuing reference now to user interface 400, input provided to user interface 400 preferably comprises the contents of one or more wallet files 140A created by wallet program 140, discussed in further detail below.

Note that such input may additionally, or alternatively, be provided to user interface 400 in a variety of other ways as well including, but not limited to, typing such as by way of a keyboard or the like, speaking, downloading from another location specified by the user, or simply the selection of an action form element (described in detail below). Because user interface 400 is preferably graphically displayed on monitor 150, a user can quickly and easily direct the operation of server 100A simply by providing input to user interface 400, either from a wallet file 140A or by way of input device 145.

Upon receipt of instructions from user interface 400, server 100A performs, or causes the performance of, one or more characteristic actions corresponding to the instructions received from user interface 400. It will be appreciated that a plurality of user interfaces 400 may be presented on client computer 100 at any one time so as to facilitate the control, manipulation, or direction of a plurality of servers 100A.

As suggested above, one useful feature of the present invention relates to the functionality of server 100A. In addition to performing, or causing the performance thereof, of one or more functions corresponding to user input received by way of user interface 400, server 100A may be configured to transmit information to client computer 100 in response to the receipt of input received at user interface 400. For example, server 100A may be configured to send a message, by way of an email program, to client computer 100 after such time as server 100A has executed the instructions provided to it by way of user interface 400.

Another useful feature of embodiments of the present invention, relating to the manipulation of server 100A, concerns the fact that the operation of server 100A can be manipulated by a user (acting through user interface 400 presented on client computer 100) to, for example, obtain/transmit information from/to a particular web page associated with user interface 400, without requiring the user to access or display such associated web page.

For example then, in the context of a global computer network comprising a plurality of computers, each computer having one or more web pages and web sites located thereon, the graphical aspects (and/or others discussed elsewhere herein) of user interface 400 cooperate with server communication link 402 to permit the user to manipulate one of such computers so as to cause that computer to respond in a characteristic fashion, thereby facilitating achievement of one or more desired results consistent with the input provided by the user.

Further, while user interface 400 is preferably graphically displayed on monitor 150, it will be appreciated that embodiments of user interfaces 400 of the present invention may also be presented to the user of client computer 100 in a variety of other ways as well. For example, other user interfaces 400 including, but not limited to, audio user interfaces, tactile interfaces, voice recognition interfaces, voice data processing interfaces, video user interfaces, and audio/video user interfaces, are contemplated as being within the scope of the present invention. Note further that any given user interface 400 may include audio, video, and graphical elements, or various combinations thereof.

Directing attention now to FIG. 2B, additional details are provided regarding various constituent elements of user interface 400, and regarding certain features of wallet program 140, wallet files 140A, and wallet program shortcut 140B. In the illustrated embodiment, user interface 400 includes, among other things, an interface structure 401. In general, interface structure 401 provides a basic framework which can be supplemented as desired to suit a particular application. As discussed below, interface structure 401 may be supplemented with items such as, but not limited to, data form elements, action form elements, graphics, or the like, so as to produce various types of user interfaces, advertisements for example, having differing appearances and functionalities.

Preferably, interface structure 401 at least partially comprises display material suitable for presentation on monitor 150. As contemplated herein, such “display material” may be presented in a variety of formats including, but not limited to, text, graphics, audio, video, audio/video and the like. In view of the foregoing, it will be appreciated that “display material” should not be construed to be limited solely to materials that are suitable for presentation on monitor 150, but rather include materials in any of a variety of formats suitable for presentation to a user by way of a variety of devices, including, but not limited to, monitor 150, audio speakers, and the like. With regard to content, the display material may include product information, service information, and/or any other information or data, as well as information or data which facilitates or otherwise contributes to the implementation of the functionality of data form elements and action form elements, discussed below.

As suggested above, interface structure 401 includes one or more data form elements 404A, 404B, 404C, and 404D, collectively indicated in FIG. 2B at 404. Generally, data form elements 404 comprise, among other things, display material as well as functional elements, and are configured to receive input entered by way of input device 145 (not shown). In particular, the display material is preferably directed towards communicating information to the user and/or prompting the user to provide specific input, and the functional element of data form elements 404 is directed toward receiving input from the user and arranging, configuring, or otherwise processing such input according to predetermined criteria that are consistent with one or more desired objectives.

It will be appreciated that data form element 404 may take a variety of forms and configurations. As an example, data form element 404 may comprise a blank field and the graphical heading “USERNAME.” In this example, the display material of data form element 404 takes the form of the graphical heading “USERNAME,” which serves to indicate to the user the nature of the information that is to be entered into the blank field of such data form element 404, and which accordingly contributes to the functionality associated with data form element 404.

It will be appreciated that the foregoing is presented solely by way of example, and that data form elements 404 may be embodied in any of a variety of different ways and/or may be configured to receive data embodied in a variety of forms. As another example, data form element 404 may be embodied in the form of a so-called “pull down” menu. In this configuration, data form element 404 does not include a blank field for receipt of input from the user, but rather provides the user with various choices which the user may then select with input device 145. An example of such a data form element 404 would be a pull down menu for indicating the state of residence of the user. In this example, the user would select data form element 404 by way of input device 145 so that the entire menu is displayed, and then the user would select the appropriate state.

A preferred vehicle for entering appropriate data in data form elements 404 is wallet program 140. Generally, as contemplated herein, “wallet program” 140 comprises software, instructions, machine language, source code, executable code, or the like which, in response to user input, creates, uses, and/or manipulates one or more data files, or wallet files 140A, containing a predefined data set specified by the user. With more specific reference to wallet files, it is contemplated hereby that “wallet file” includes, but is not limited to, databases, data structures, and the like, each of which contains, or may contain, one or more data sets defined by a user or users.

In one embodiment of the invention, such a predefined data set comprises various personal data concerning a particular user such as shoe size, shirt size, color preferences, and the like. It will be appreciated that the functionality of wallet program 140 may be embodied in any of a variety of media including, but not limited to, optical media, magnetic media, and the like. Preferably, the initialization of wallet program 140 is accomplished by way of wallet program shortcut 140B which causes such initialization when selected by the user by way of input device 145 (not shown) or the like.

As noted in the context of the discussion of FIG. 2A, wallet files 140A created by wallet program 140 are stored in system memory 104 of client computer 100. Such an arrangement provides a significant convenience because it permits a user to, among other things, readily access, create, modify, delete, or otherwise manage and control wallet files 140A. Further, this feature, at least, represents an advancement over prior art systems wherein wallet files are located at a location remote from client computer 100, such as a server or the like, in that a user can readily access wallet files 140A, and perform various operations regarding them, without having to logon, or otherwise connect to, a remote server or other remote location. Finally, the fact that wallet files 140A are stored locally at client computer 100 serves to, among other things, enhance the security of wallet files 140A because only the user with whom wallet files 140A are associated has access to such wallet files In contrast, wallet files stored at a remote server may be vulnerable to uncontrolled accidental releases, and to attacks by hackers and other unauthorized users.

With continuing attention to various features of wallet files 140A, in at least one embodiment of the present invention, the user has the option of specifying a particular format, text for example, for the data in the file. Finally, wallet files 140A may be named according to any convention(s) suitable and appropriate in light of the contemplated uses thereof.

An exemplary wallet file 140A, such as would be suitable for use in the context of on-line shopping, contains consumer information including, but not limited to, the name, address, telephone number, email address, and credit card or debit card number of the consumer, that is appropriate for uploading to a corresponding user interface 400. It will be appreciated that the contents of wallet files 140A can be readily customized to suit a variety of situations. By way of example, a single wallet file 140A may contain multiple credit card numbers, multiple telephone numbers, and/or multiple email addresses, depending on the needs of a particular user. Thus, for example, even if a user places multiple orders for products or services from a particular vendor, the user may, at his option, select a different credit card for each order.

In one alternative embodiment, wallet file 140A does not contain specifically tailored information but rather contains a wide variety of information that can be selectively sorted through by wallet program 140 so that only data corresponding to the data requirements of a particular user interface 400 are extracted by wallet program 140. Such a wallet file 140A would obviate the need for a user to develop multiple specific-use wallet files 140A. Thus, in an on-line shopping context, for example, wallet file 140A might contain information such as shoe size, shirt size, home address and credit or debit card number. For a shoe purchase however, the shirt size data would not be required and accordingly, would not be extracted by wallet program 140 for uploading to user interface 400.

In view of the foregoing, it will be appreciated that any number of wallet files 140A, each containing a different “block” of predefined data, may be created and stored at client computer 100. By way of example, a plurality of individual wallet files 140A, each corresponding to an authorized user of client computer 100, may be employed that permit multiple authorized users, each using a unique wallet file 140A or “profile,” to order goods and services from client computer 100. Preferably, each wallet file 140A is configured for various security measures including, but not limited to, password-based access, so that a given user can access only his own unique wallet file 140A.

Furthermore, as suggested above, the data contained in a given wallet file 140A may be configured so as to take a particular form, wherein such forms include, but are not limited to, plain text, hypertext markup language (HTML), or the like. In some cases, some portions of the data contained in a wallet file 140A are in a format different than that of other portions of data in the same wallet file 140A. At least some embodiments of wallet program 140 further include a translation functionality so that, prior to uploading to user interface 400, wallet program 140 determines the format and configuration of user interface 400 and then translates the data in wallet file 140A into a form or format compatible with the particular user interface 400 which is to receive the data.

As suggested above, various embodiments of wallet program 140 and wallet files 140A also provide for protection of wallet files 140A, by a password for example, so that access cannot be gained except by authorized persons. Such a security measure protects unauthorized viewing and/or use of the contents of wallet files 140A.

Turning now to a discussion of various operational features, embodiments of wallet program 140 are preferably configured so that a user can simultaneously enter data into a plurality of data form elements 404, or “populate” such data form elements, of user interface 400 by displaying wallet files 140A and then using input device 145 to simply “drag and drop” a desired wallet file 140A onto the desired user interface 400. More specifically, wallet program 140 enables a user to view a plurality of graphical representations, such as icons or the like, each of which corresponds to a wallet file 140A. To perform the population of data form elements 404, the user simply positions a pointer associated with input device 145 over the icon representative of the desired wallet file 140A and then “drags and drops” that icon onto the desired user interface 400. For example, a wallet file 140A containing shoe size, shirt size, and shirt color would be used to simultaneously populate corresponding data form elements 404 adapted to receive, respectively, shoe size, shirt size, and shirt color.

It will be appreciated that the foregoing is simply an exemplary method for populating data form elements 404, and that data form elements 404 may be populated in a variety of different ways. In general, any method, device, or combination thereof that facilitates or promotes simultaneous population of a plurality of data form elements with appropriate corresponding data is contemplated as being within the scope of the present invention.

As another example, data form elements 404 may be populated by selecting, with user input device 145, a desired user interface 400 and then attaching the desired wallet file 140A thereto. In any event, population of data form elements 404 by the user causes the generation of a data form element selection signal indicative of input device 145 (not shown) entering data in data form element 404. In one embodiment of the present invention, the data form element selection signal is used to facilitate definition of an order for products or services.

The functionality provide by wallet program 140 and wallet files 140A implicates a variety of benefits. By way of example, embodiments of the present invention obviate the need for a user to re-enter data by hand each time a particular user interface 400 is presented. As another example, such embodiments permit a user to enter desired data in multiple user interfaces 400 much more quickly than such entry could be accomplished manually. In particular, embodiments of the present invention permit a user to populate multiple data form elements 404 simultaneously, whereas hand entry of data into form elements 404 necessarily proceeds serially. Finally, because the data is predetermined by the user and stored in wallet file 140A, the possibility of data entry errors when data is uploaded to data form elements 404 is virtually eliminated.

As noted above, wallet program 140 includes functionality which permits it to access and classify a particular user interface 400 and then translate or reformat, if necessary, the data desired to be entered in such user interface 400. Accordingly, embodiments of wallet program 140 are configured to display a feedback message on monitor 150 at such time as any translation/reformatting has occurred and all desired data is properly and completely loaded into user interface 400. Finally, embodiments of wallet program 140 also include an “UNLOAD” feature, preferably manifested as a user-selectable button on monitor 150, which allows a user to quickly and easily remove information uploaded from a wallet file 140A to user interface 400.

With respect to the foregoing discussion regarding various features and functionalities of wallet program 140 and wallet files 140A, it will be appreciated that variables including, but not limited to, data format, data content, security features, data translation capabilities, and the like, may be varied either alone or in various combinations, as required to suit a particular application or environment, or to facilitate achievement of one or more desired results.

With continuing reference now to FIG. 2B, additional details are provided regarding various features of an embodiment of user interface 400. In particular, user interface 400 additionally includes information 406 that is of interest to the user. Information 406 may be presented to the user in any of a variety of ways and may comprise graphical information, textual information, audio files, video files, and various other types of media or combinations thereof.

Further, user interface 400 may additionally include one or more hyperlinks 408 In one embodiment of the present invention, hyperlink 408 cooperates with browser 142 (see FIG. 1) to cause a web page associated with that hyperlink to be accessed and displayed on monitor 150. It will be appreciated that a plurality of hyperlinks 408 may be employed in the context of user interface 400. Furthermore, hyperlink 408 may be configured to facilitate the display or presentation of media other than a web page. For example, hyperlink 408 may be configured to cooperate with word processing programs and the like, so that upon selection of hyperlink 408 by the user, one or more associated documents are presented on monitor 150.

Finally, user interface 400 includes a plurality of action form elements 4100A, 410B, and 410C, collectively denoted in FIG. 2B as 410. Similar to data form elements 404, action form elements 410 comprise, among other things, graphical elements and functional elements. In general, action form element 410 is displayed on user interface 400 and configured so that upon selection of action form element 410 by a user, by way of input device 145 (not shown), one or more actions concerning user interface 400 are performed. By way of example, after information has been entered into one or more data form elements 404, a user may then wish to send that data to server 100A. An action form element 410 having data transmission functionality would be effective in this regard.

For example, by selecting a “SEND” action form element 410, a user would thereby cause the generation of an action form element selection signal indicative of the input device providing input to the action form element. In one exemplary embodiment, such an action form element selection signal then causes the data contained in data form elements 404 to be sent to server 100A and/or to any other appropriate destination. In other embodiments, user interface 400 may be configured to additionally include programming code and the like such as would permit user interface 400 to process, at the client computer, data input by the user prior to sending such data to the server. Note that receipt, by embodiments of user interface 400 of a user-initiated request for action with respect to data received by user interface 400 may be generally referred to herein as an ‘action request.’

In general then, action form elements 410 are configured to cause, at least indirectly, the performance of one or more actions upon their selection by a user. It will accordingly be appreciated that action form elements 410 may comprise any of a variety of combinations of graphical and functional elements. It will further be appreciated that, in addition to directing the action of user interface 400 with respect to information entered in data form elements 404, action form elements 410 may additionally, or alternatively, be profitably employed to direct the actions of server 100A upon receipt by server 100A of instructions from action form element 410.

With reference now to FIG. 2C, and with continuing reference to FIGS. 2A and 2B, various additional details are provided regarding an embodiment of a process, designated generally at 500, employing a user interface consistent with the teachings of the present invention. It will be appreciated that the steps of the process indicated in FIG. 2C, as well as the steps of the processes disclosed elsewhere herein, need not necessarily proceed in the order indicated, and that the order of some or all steps may be rearranged and varied as required to suit a particular application and/or to facilitate achievement of one or more desired results.

In step 502 of process 500, a user interface is created and stored at one or more servers. It will be appreciated that at least the creation of the user interface may take place at a location other than the server, however. The user interface thus created may then be downloaded or otherwise transferred to one or more desired servers.

Upon storage of the user interface(s) at the server, step 504 is entered wherein a copy of the user interface is generated and the copy thus produced has a server communication link, or links, embedded therein so as to facilitate communication between the client computer and one or more servers. It will be appreciated that such a server communication link may be embodied in any of a variety of different ways. For example, such a server communication link may comprise computer code or the like, which, upon fulfillment of one or more preconditions, would initiate a communications program or the like so as to facilitate communication between the computer to which the user interface is downloaded (see step 506) and the server with which the server communication link is associated.

After creation of the user interface copy, the linked copy of the user interface is then downloaded to one or more client computers in step 506. It will be appreciated that the downloading of such linked copy of the user interface may be performed in accordance with the wide variety of criteria. For example, user interfaces may be downloaded to the client computer at the initiative of the user. As another example, the user may specify that one or more user interfaces are to be downloaded to the client computer periodically in accordance with a predetermined time interval. Such a downloading scheme may be employed in cases where the client computer is configured for continuous communication with the server. In cases where the client computer accesses the server by way of dial-up access, the user interface(s) would be downloaded to the client computer at such time as the user establishes communication between the client computer and the server.

After one or more user interfaces have been downloaded to the client computer, step 508 of process 500 is entered wherein one or more of the downloaded user interface(s) are displayed at the client computer. It will be appreciated that such display of downloaded user interface(s) may occur when the client computer is “on-line,” or in communication with the server, and/or when the client computer is in an “off-line” status where communication between the client computer and the server has been disestablished. Further, as discussed elsewhere herein, the user interfaces may be downloaded to the client computer either alone or in the context of various types of electronic media, including, but not limited to, e-books, electronic periodicals, web pages, and the like. By way of example, an electronic book available for downloading may have embedded therein various user interfaces so that when the electronic book is downloaded to the client computer, the user interfaces will be available to the user. Finally, at such time as the user views the downloaded user interface(s), the user may then decide whether or not to enter any data into a particular user interface, and whether or not to initiate any action with respect to any such data entered.

In the event the user decides to interact with the user interface, step 509 of the process is entered wherein the user selects an appropriate wallet file and then uploads the contents of the wallet file to the user interface. Subsequently, in step 510, the data form elements of the user interface receive the data uploaded from the wallet file. Upon completion of step 510, step 512 of process 500 is entered wherein the user selects, by way of an input device at the client computer, one or more action form elements of the user interface corresponding to actions that the user desires to take place with regard to the data entered by the user in the data form elements of the user interface.

As indicated in step 514 of process 500, selection of an action form element by the user preferably causes transmission to the server of instructions corresponding to input received at the data form elements and/or the action form elements of the user interface, but may cause additional or alternative actions as well. In the event the client computer is off-line at the time the action form element is selected, one or more of the action(s) corresponding to the selected action form element are held in abeyance, and executed the next time that the client computer establishes communication with the server. Alternatively, in the case of a “SEND” action form element for example, selection of that action form element will cause an off-line client computer to then establish communication with the server, by way of a modem or the like, so that the instructions may be transmitted from the client computer to the server. In one embodiment of the invention, the user may select and/or specify the protocol to be followed when one or more action form elements are selected.

Finally, step 516 of process 500 is entered wherein the user interface at least indirectly causes, by way of the server, the performance of one or more actions corresponding to the input entered at the data form elements and the action form elements of the user interface and transmitted to the server. Examples of such actions performed by way of the server include, but are not limited to, data gathering, data transmission, email communication, and the like.

It will be appreciated that the functionality of embodiments of the user interfaces, such as those discussed in the context of FIGS. 2A through 2C, may be employed in a wide variety of applications and environments. For example, because such user interfaces provide all necessary relevant information, they may be used in the context of web pages to permit viewers to quickly and easily sign up for, or request information regarding, for example, lectures, conferences and the like relating to such web pages. In this example, a user interface may include information such as the time, place, and subject of a particular lecture The user might then sign up for the lecture simply by entering his name and phone number into the user interface and then causing that data to be transmitted to the server associated with the user interface.

As another example, such user interfaces may be used in the context of on-line academic courses. In such an application, the user interfaces could be used to transmit student answers to one or more predetermined locations for grading or evaluation. Additional exemplary applications for user interfaces of the present invention are discussed in detail below.

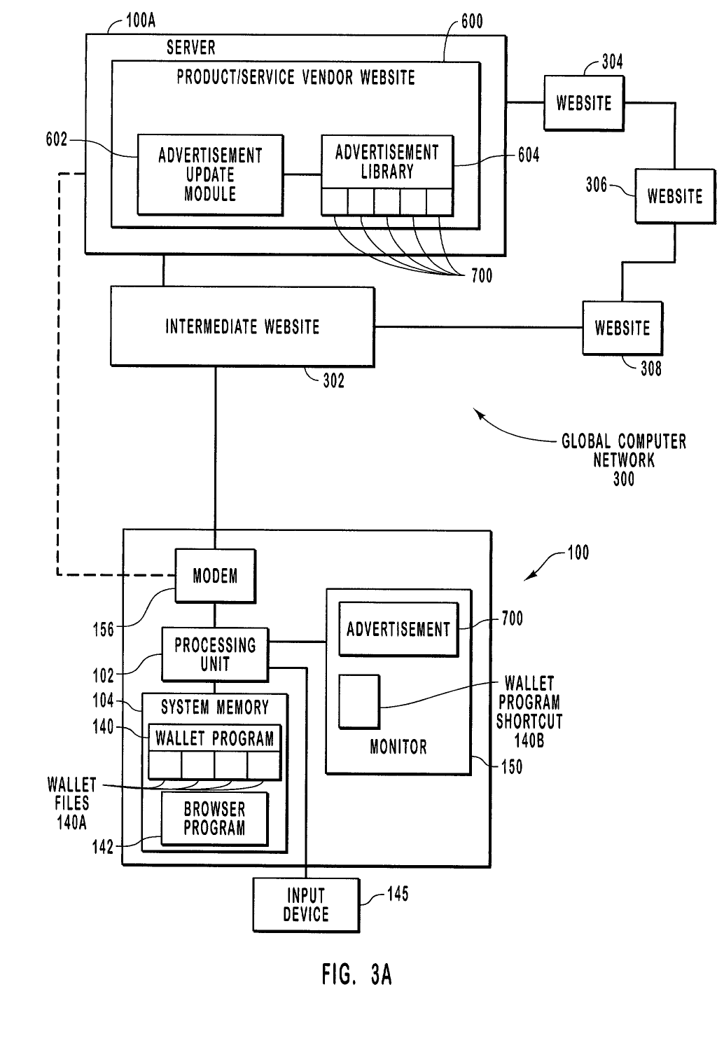

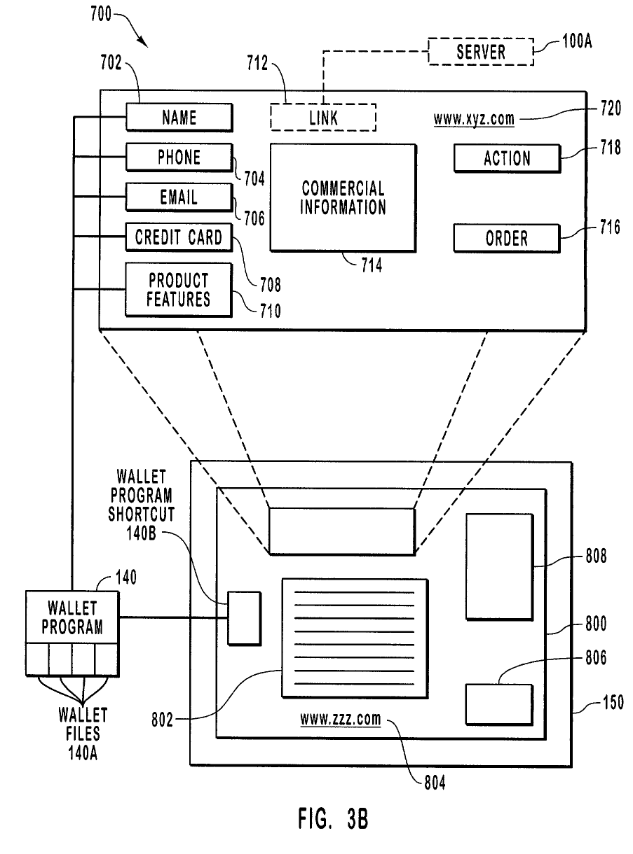

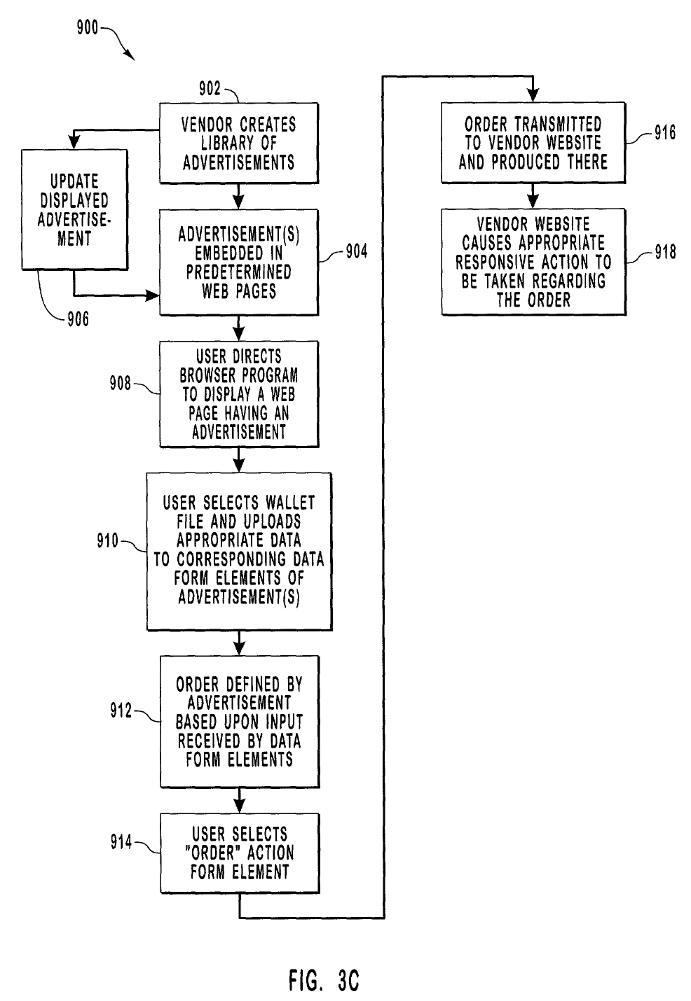

Attention is now directed to FIG. 3A, where various details of one such exemplary application of an embodiment of the present invention are illustrated. In general, FIG. 3A illustrates various details of a user interface, and a method for using it, employed in the context of on-line commerce.

In particular, this embodiment is employed in the context of global computer network 300. As indicated in FIG. 3A, global computer network 300 includes intermediate website 302, discussed in further detail below, various other websites 304, 306, 308, and a product/service vendor website 600 located at server 100A. Client computer 100, configured for communication with global computer network 300 and, thus, intermediate website 302 and product/service vendor website 600, includes a processing unit 102, system memory 104 having stored therein wallet program 140, wallet files 140A, browser program 142, input device 145, monitor 150, and modem 156.

With continuing reference to FIG. 3A, server 100A additionally includes advertisement update module 602 and advertisement library 604, both of which are configured for operative relation with intermediate website 302. It will be appreciated that advertisement update module 602 and advertisement library 604 may reside on server 100A outside the context of product/service vendor website 600, or may reside at another server. Alternatively, the functionality of advertisement update module 602 and advertisement library 604 may be incorporated within the context of product/service vendor website 600. Specific features of the methods associated with the embodiment of the present invention illustrated in FIG. 3A are discussed below in the context of FIG. 3C.

In general, advertisement library 604 includes one or more advertisements 700 stored therein. Preferably, advertisements 700 comprise banner advertisements or the like. However, any advertisement embodying the functionality of advertisement 700, as disclosed herein, is contemplated as being with the scope of the present invention. Advertisement library 604 is configured for communication with advertisement update module 602. Preferably, advertisement update module 602 comprises software, computer code, or the like configured to establish and/or employ criteria for governing which advertisements 700 are presented on web pages associated with intermediate website 302. In a preferred embodiment, product/service vendor website 600 is distinct from intermediate website 302 where advertisements 700 are displayed. However, it will be appreciated that in an alternative embodiment, product/service vendor website 600 and intermediate website 302 may be one and the same.

Generally, advertisements 700 stored in advertisement library 604 are displayed or otherwise presented on intermediate website 302 as agreed upon by the respective owners of product/service vendor website 600 and intermediate website 302. In any event, embodiments of advertisements 700 are preferably configured and arranged (within the context of the web page wherein they are displayed) so that each contains all the information and functionality necessary to facilitate definition and placement of an order for the good(s) and/or service(s) with which the particular advertisement 700 is concerned. That is, the information and functionality implemented within advertisement 700 should be sufficiently comprehensive and complete that a user may define and place an order without having to access web sites or web pages other than the one within which advertisement 700 is displayed.

Consistent with the foregoing, each advertisement 700 preferably contemporaneously presents all of the information that a prospective consumer would consider relevant and necessary to the sale of a particular good or service, wherein such information may include, but is not limited to, one or more graphical representations of the product/service, information concerning the vendor of the product/service, price, shipping information, and any other pertinent information. Likewise, note that the aforementioned features regarding the information and functionality implemented within embodiments of advertisements 700 are equally germane where such advertisements are employed in the context of electronic texts 1200 and the like, discussed below.

Thus, embodiments of advertisement 700 are useful to the vendor because they permit a vendor to, among other things, readily provide, in a single “stand-alone” advertisement, all the information and functionality necessary to permit a consumer to define and place an order for the goods and/or services of the vendor associated with the particular advertisement 700. As a result, the vendor does not have to rely on the relatively ineffective vehicle of banner advertisements that typically require users to click through to the vendor web site in order to define and place an order. The aforementioned feature is similarly attractive to prospective consumers because, among other things, consumers need not access a multiplicity of web pages, nor engage in time-consuming product and service searches in order to define and place an order. Rather, all the information and the functionality that the user needs to define and place an order is presented to the user, simultaneously, in advertisement 700. This type of convenience serves to increase the likelihood that prospective consumers will make a purchase.

As noted above, criteria governing the downloading and display of advertisements 700 with respect to intermediate website 302, may be embodied in advertisement update module 602. It will be appreciated that there are virtually unlimited number of schemes and variables which may be used to control the downloading and/or display of advertisements 700.

By way of example, advertisements 700 presented on intermediate website 302 may be refreshed every time the presentation of a web page from intermediate website 302 on monitor 150 is refreshed by browser program 142. As another example, advertisements 700 presented on intermediate website 302 may be updated on a periodic basis, for example, daily. As another example, intermediate website 302 may incorporate functionality that permits the user to specify certain areas of interest such that the advertisements 700 presented on intermediate website 302 would correspond to areas of interest indicated by the user. It will be appreciated that the foregoing is by no means an exhaustive enumeration of criteria that may be employed to govern the downloading and/or display of advertisements 700 and, accordingly, should not be construed or interpreted to limit the scope of the present invention in any way.

Directing attention now to FIG. 3B, further details are provided regarding an embodiment of advertisement 700. Advertisement 700 is preferably displayed within the context of a web page display 800 appearing on a monitor 150 of a client computer (not shown) Typically, web page display 800 includes, or may include, text 802, hyperlinks 804, graphics 806, and/or various types of multimedia 808. Further, advertisement 700 includes various data form elements, action form elements, and other features, which serve to facilitate ordering products and/or services by way of global computer network 300 without requiring the user to actually visit the website or web page of the vendor in whose product or service the user in interested.

In general, the data form elements of advertisement 700 are selected to permit uploading of consumer information to advertisement 700. As contemplated herein, “consumer information” includes any and all information unique to a particular consumer, wherein such consumer information includes, but is not limited to, clothing and shoe sizes, email address, home address, credit or debit card number, credit or debit card expiration date, product and/or service preferences, hobbies, book subject matter, or the like. “Consumer information” also contemplates as being within its purview, combinations which include elements of information that, when considered separately, may not be unique to a particular consumer, but when considered in the aggregate are unique to a consumer. By way of example, a credit card expiration date may be the same for many consumers, but the combination of a credit card expiration date and credit card number is unique.

In the illustrated embodiment, advertisement 700 includes a name form element 702, a phone number form element 704, an e-mail form element 706, a payment form element 708, and a product features form element 710. As their names suggest, the aforementioned form elements are configured to receive various specific data from the user relevant to the purchase of the products and/or services with which advertisement 700 is concerned.

Preferably, the data entered into data form elements 702 through 708, at least, resides in one or more wallet files 140A and is uploaded to advertisement 700 by way of wallet program 140. As the mechanics of the operation of embodiments of wallet file 140A and wallet program 140 have been discussed above in the context of FIGS. 2A through 2C, additional discussion thereof is not required at this juncture. However, it will be appreciated that, in the context of the present embodiment at least, the data contained in wallet file 140A preferably comprises consumer information including, but not limited to, name, phone number, email address, and credit or debit card number. It will further be appreciated that the data required to be entered in advertisement 700 is exemplary and may vary from one vendor to another in accordance with the requirements of each particular vendor.

As discussed in the context of various other embodiments of the present invention, advertisement 700 additionally includes a server communication link 712, which serves to facilitate communication of data, received by advertisement 700, from client computer 100 (not shown) to server 100A. Advertisement 700 additionally includes commercial information 714. It will be appreciated that commercial information 714 may take any of a variety of forms, including, but not limited to, text, graphics, audio, video, multi-media, or various combinations thereof, and may include such information as, but not limited to, price, color, availability, size, and any other such information regarding a particular product or service as may be of interest to a consumer.

In addition to its ability to receive various data uploaded or otherwise input by a user, advertisement 700 also preferably includes provision for the performance of one or more actions relating to the data or information received by advertisement 700. By way of example, some embodiments of advertisement 700 include an “ORDER” form element 716. As discussed in the context of various other embodiments of the present invention, “ORDER” form element 716 belongs to the more general category of action form elements. In particular, when a user selects “ORDER” form element 716, the data received by form elements such as name form element 702, phone form element 704, e-mail form element 706, payment form element 708, and product features form element 710, is caused to be transmitted to server 100A.

Preferably, advertisement 700 will return an error message in the event an action is selected that is inconsistent with the data present in the data form elements. For example, if the data entered by the user is incomplete, selection of the “ORDER” button will cause a message to be displayed indicating that the order cannot be sent until all requisite data is provided to advertisement 700.

It will be appreciated that a variety of other action form elements 718 may likewise be employed in the context of advertisement 700. For example, action form element 718 may comprise “CANCEL” functionality, so that in the event a user decides not to order the product(s) or service(s) featured in advertisement 700, the user may thereby cancel his order. As another example, action form element 718 may comprise “CHECK AND CONFIRM,” or similar, functionality so as to enable a user to check and verify the accuracy and completeness of the data entered in the various data form elements prior to transmitting an order to server 100A. It will be appreciated that the aforementioned functionalities are provided by way of example, and accordingly should not be construed to limit the scope of the present invention in any way.

Finally, one embodiment of advertisement 700 includes a vendor website hyperlink 720 While one feature of embodiments of the present invention is that products and services can be ordered by way of global computer network 300 without necessitating the accessing of the vendor website, vendor website hyperlink 720 permits a user to visit the vendor website in the event the user desires additional information regarding the product or service featured in advertisement 700 and/or information regarding other products of the particular vendor.

As suggested in the foregoing discussion, embodiments of advertisement 700 possesses a number of useful features. For example, advertisement 700 is configured to receive data input by a user and to cause one or more actions to be performed which relate to that data As another example, advertisement 700 allows a vendor to greatly simplify the process by which consumers access and order his products and/or services because all of the information relevant to the purchase of a particular product or service is presented to the user in the context of advertisement 700. As a final example, advertisement 700 allows a user to quickly and easily order a desired product or service without having to engage in a search of global computer network 300 for such product or service.

It will be appreciated that because product/service ordering is readily and quickly achieved with embodiments of the present invention, a vendor may well realize a relative increase in sales volume as a function of advertising. That is, because embodiments of the present invention permit a user to quickly and easily order products and services without having to search for them, the barrier of inconvenience is removed from the ordering process. As a result of this more convenient ordering process, a user is likely to be more inclined to make a purchase.

Further, it will be appreciated that a vendor need not maintain a vendor website on the global computer network in order to benefit from the functionality provided by the present invention. For example, such a vendor could arrange to have advertisements produced and displayed on various intermediate websites. A communication link in such advertisements would be configured to receive an order placed by a user, in the manner described elsewhere herein, and to transmit such order to, for example, a vendor fax machine, voice mail box, email program or the like.

Directing attention now to FIG. 3C, and with continuing attention to FIGS. 3A and 3B, various features of an exemplary process and method for using embodiments of advertisement 700 are indicated. Process 900 commences with step 902, where a vendor creates one or more advertisements directed to various products and services supplied by that vendor. One or more of the advertisements thus produced are then displayed, on an intermediate website owned by a client with whom the vendor has an agreement, according to various criteria specified by the vendor and the client and/or criteria embodied in an advertisement update module. As noted in the context of the discussion of FIG. 3A, the advertisements created by the vendor and displayed on the display website of the client may be updated, refreshed, or replaced according to various predetermined criteria (see step 906).

In step 904 of process 900, one or more of the advertisements created by the vendor are embedded in one or more web pages of the intermediate website so that when such web pages are accessed and displayed on the client computer, the advertisements thus embedded will likewise be displayed substantially contemporaneously with the web page(s). In step 908, the user then directs a browser program resident on the client computer to access and present the web page(s) containing the embedded advertisements.

At this point in process 900, the user is free to review the product information presented on the advertisement and consider whether or not he desires additional information regarding the product and/or whether he would like to order the product(s) and/or service(s) that are the subject of the advertisement. In the event the user decides to order the product presented on the advertisement, step 910 is entered wherein the user selects an appropriate wallet file and uploads the contents, or an appropriate portion thereof, of the wallet file to the corresponding data form elements of the advertisement.

As a result of the receipt of this data, an order unique to the user is thereby defined in step 912. Once the requisite data form elements have been completed, the user may then decide to cause the order to be transmitted to the server for processing.

In order to effectuate such transmission, step 914 is entered wherein the user selects the “ORDER” action form element of the displayed advertisement. In step 916 of process 900, the order defined by the advertisement is then transmitted from the client computer to the server for further processing. In step 918, the receipt of the order at the server causes the server to perform one or more desired actions with respect to that order. In one embodiment, such actions include, processing, packaging, and shipping the order, in a manner well known in the art, to a location specified by the user.

It will be appreciated however that various other, or additional, actions may be performed by the server in response to receipt of the order. By way of example, the server may, upon receipt of the order from the user, transmit feedback to the user concerning the order. Such feedback may include an e-mail message to the e-mail address designated by the user, indicating that the order has been received and has been submitted for further processing. As another example, the server may automatically send periodic messages to the user concerning the status of the order.

As yet another example, the server may transmit additional advertisements to the user wherein such additional advertisements are selected by the server based upon criteria identified by the user Thus, if the user were to order a bicycle by way of the advertisement, the responsive message sent by the server may include additional advertisements directed to bicycle repair parts, bicycle clothing, and various other related items or services. In this way, the ordering of additional items by way of the global computer network is facilitated without requiring the user to visit the website(s) of the vendors whose products are the subject of the responsive advertisements.

It will be appreciated that the foregoing are presented merely by way of example and that the actions performed by the server, or at the direction of the server, in response to receipt of an order from the user may vary widely. Accordingly, the aforementioned examples should not be construed to limit the scope of the invention in any way.

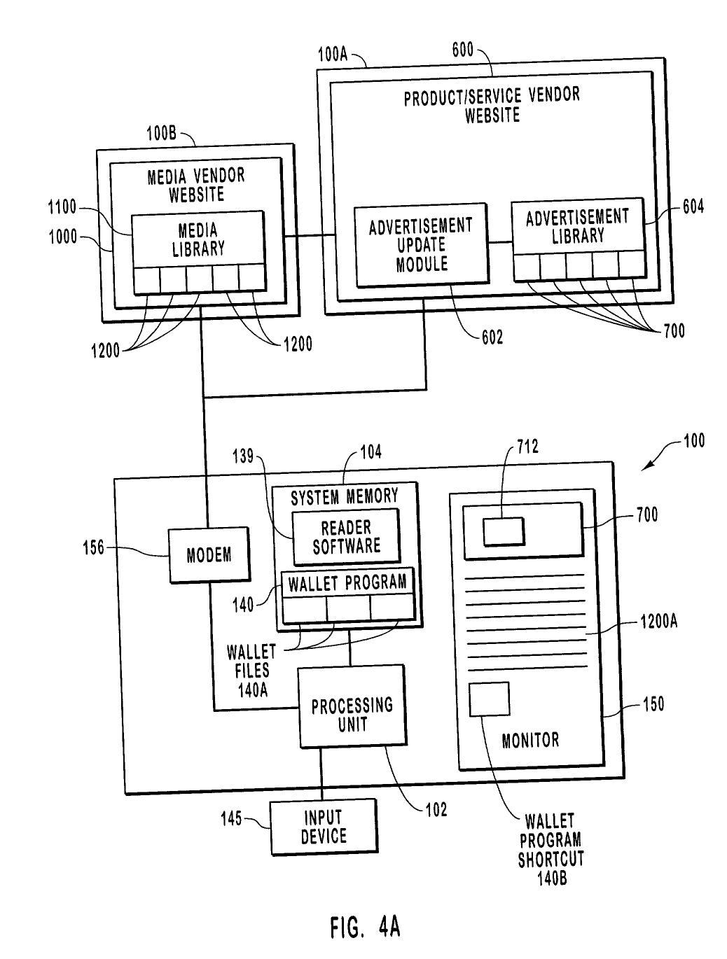

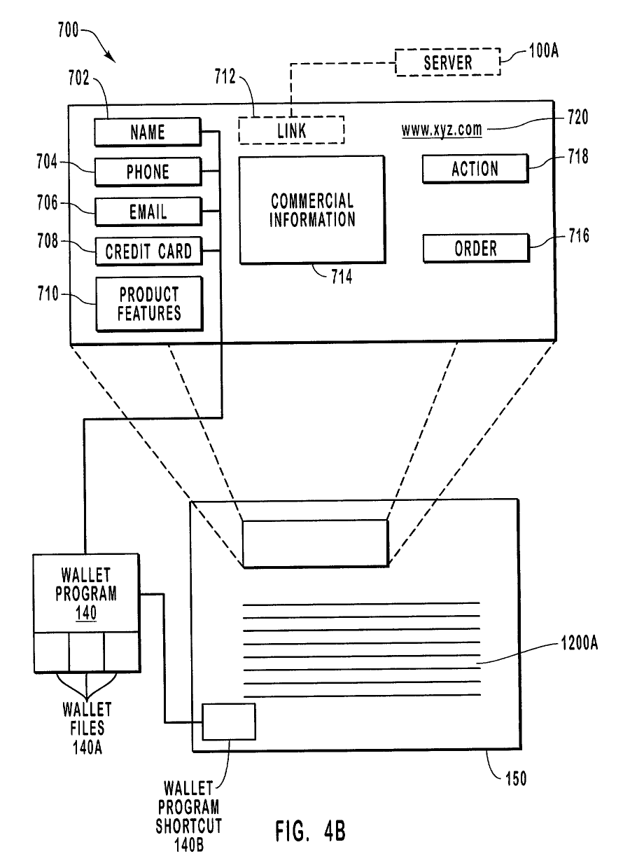

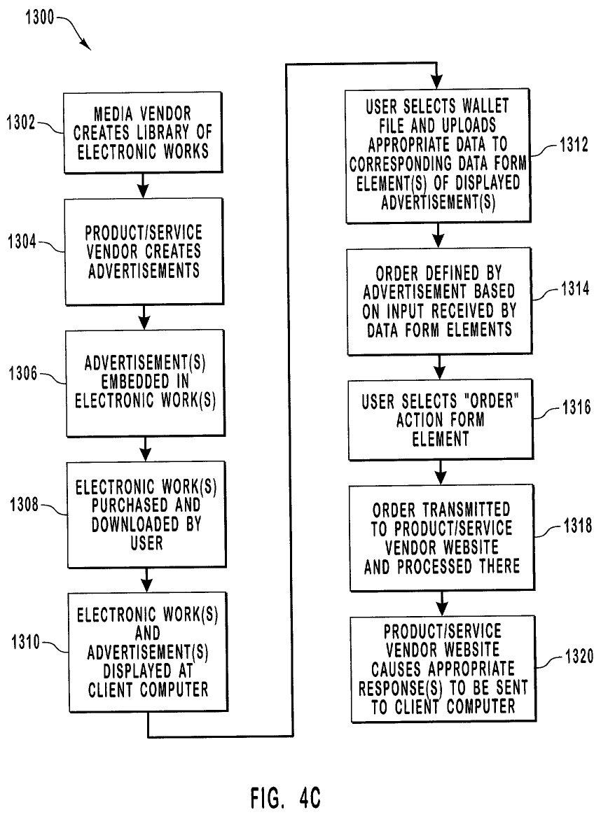

Turning now to FIG. 4A, various details are provided concerning the use of embodiments of the present invention in the context of electronic media such as e-books, journals, newspapers, newsletters, magazines, and the like. Note that, with respect to the following discussion of FIGS. 4A through 4C, the features relating to the information and functionality implemented within embodiments of advertisements 700 include, among others, those presented above in the context of the discussion of FIGS. 3A through 3C and, accordingly, the discussion of such features need not be renewed here. Rather, the present discussion will focus primarily on one exemplary context in which embodiments of advertisement 700 may be employed.

As indicated in FIG. 4A, client computer 100 is capable of communicating with a product/service vendor website 600, and with a media vendor website 1000 located at server 100B. In one embodiment of the present invention, product/service vendor website 600 and media vendor website 1000 are located on one or more servers in communication with global computer network 300 (not shown). As such, product/service vendor website 600 and media vendor website 1000 are likewise capable of communication with each other. As various features and details of product/service vendor website 600 have been discussed elsewhere herein in the context of various other embodiments of the present invention, only those features that are particularly germane to the present embodiment will be addressed in further detail in the present discussion.

With continuing reference now to FIG. 4A, media vendor website 1000 includes a media library 1100, having a plurality of electronic texts 1200. It will be appreciated that electronic texts 1200 may take any of a variety of forms. As an example, electronic texts 1200 may comprise e-books or the like that are suitable for viewing with reader software 139. Electronic texts may also include, but are not limited to, periodicals, magazines, newspapers, and the like, suitable for presentation at a computer. Note that embodiments of reader software well-suited for downloading, viewing, and manipulating electronic texts 1200 and other electronic media are disclosed and claimed in the '983 Application.

In general, advertisements 700 created by the owner of product/service vendor website 600 are transmitted, downloaded, or otherwise conveyed to the media vendor. The media vendor then embeds one or more advertisements 700 in one or more of electronic texts 1200. It will be appreciated that a virtually endless variety of schemes may be employed to determine which advertisements 700 are embedded in which electronic texts 1200 and in what configuration such advertisements 700 appear in electronic texts 1200. Such schemes may be defined by the media vendor, by the products or service vendor, or by way of a collaborative effort between the media vendor and the product/service vendor.

Note that while an in-depth discussion of the operation of advertisement library 604 and advertisement update module 602 is not provided herein, details regarding embodiments of methods and systems for creating and updating advertisements are disclosed and claimed in the '983 Application. As it will be appreciated that there are a variety of methods and systems that may be devised and employed for updating such advertisements as are contemplated by the present invention, the scope of the present invention should not be construed to be limited to the embodiments disclosed and claimed in the '983 Application.

In one example, an electronic text 1200 concerning fishing may include various advertisements 700 directed to fishing equipment, fishing trips, fishing lodges, or the like. As another example, a consumer of electronic texts 1200 produced by the media vendor may provide preference data to the media vendor by way of media vendor website 1000, so that the media vendor is then able to include in electronic texts 1200 purchased by the user various advertisements 700 consistent with the input provided by the user.

In one embodiment, all advertisements 700 that are to be placed in a particular electronic text 1200 are in place at the time that electronic text 1200 is purchased and downloaded by a user. In this embodiment, advertisements 700 presented in electronic text 1200 do not change over time. In another embodiment, a user may elect to read an electronic text 1200 by a streaming process or the like wherein electronic text 1200 is downloaded “on demand,” for example, at a pace consistent with that which the user reads individual pages of electronic text 1200.

In such a streaming arrangement, it will be appreciated that that portion of electronic text 1200 which remains to be viewed by the user can include advertisements 700 that may be periodically refreshed. For example, if an advertisement 700 initially included in electronic text 1200 is overcome by events and out of date as the result of the passage of time, such advertisement 700 could then be updated if not already viewed by the user. Additionally, or alternatively, one or more electronic texts 1200 in media library 1100 may be continuously updated by advertisement update module 602 of product/service vendor website 600 In this way, assurance can be had that, at any given moment, electronic texts 1200 available for downloading contain the latest versions of advertisement 700.

In another embodiment, the vendor may provide a plurality of advertisements 700 to the media vendor and the media vendor, in his discretion, can specify variables such as the type and number of advertisement 700 to be included in any given electronic text 1200. In yet another alternative embodiment, no product/service vendor website 600 is provided and the media vendor may design its own advertisement(s) 700 for inclusion in electronic text 1200 In this embodiment, advertisements 700 and wallet files 140A may be configured by the media vendor to conform to standards or protocols that are proprietary to the media vendor. Finally, the media vendor may include a mix of media vendor advertisements 700 and product/service vendor advertisements 700 in electronic text 1200.

In operation, one or more electronic texts 1200 are downloaded to client computer 100 and one or more pre-selected advertisements 700, as well as wallet program shortcut 140B, are displayed on monitor 150 contemporaneously with the display of the words of the currently viewed electronic text 1200. Thus, as the reader views electronic text 1200 on monitor 150, the reader is periodically presented with various advertisements 700 embedded in electronic text 1200. It will be appreciated that the scheme by which advertisements 700 are presented to the reader may be configured in any of a variety of different ways as required to suit a particular application and/or to facilitate achievement of one or more desired results.

By way of example, advertisements 700 are preferably configured and arranged within electronic text 1200 so that each advertisement 700 is static within the context of the page where it is displayed. That is, such advertisements 700 preferably do not move, flash, make sounds, or otherwise provide unexpected visual, audio, or other stimuli to the reader of electronic text 1200. Further, the display of advertisements 700 is preferably indexed to a page turn initiated by the reader so that upon turning a predetermined page, or pages, the reader is presented with an advertisement 700 different than those already presented to the reader. Accordingly, the user is able to exercise some measure of control over the timing of the display of advertisements 700. Additionally, because the new advertisement 700 appears substantially contemporaneously with the page turn, the user is not distracted by unexpected motion, noise, or the like, associated with the display of the new advertisement 700.

Finally, it will be appreciated that the display, and clearing, of advertisements 700 within the context of electronic text 1200 may be indexed to various other events, instead of, or in addition to, a page turn, as well. As another example, the display and clearing of advertisements 700 may additionally, or alternatively, be indexed to the downloading of another, different, electronic text 1200 or, alternatively, an article from a web site, containing a different set of advertisements 700. Again, the display of advertisements 700 occurs at least in part as a result of an action initiated by the reader. In view of the foregoing, it will be appreciated that the scope of the present invention should, accordingly, not be construed to be limited to the exemplary configurations disclosed herein.

Thus, embodiments of the present invention provide a variety of useful features. Generally, when used in conjunction with reader software 139, embodiments of advertisement 700 include all the functionality and information necessary to facilitate definition and placement of an order for products and/or services. Thus, considered in the context of electronic texts 1200, embodiments of advertisement 700 provide an effective and efficient advertising and sales vehicle. Further, because changes in displayed advertisements 700 are preferably indexed to page turns of electronic text 1200, a vendor can employ multiple complete ads, in a single electronic text, that efficiently utilize the allocated advertising space in a manner that is not distracting or irritating to the consumer.

Should the reader, while viewing an electronic text 1200, decide to order a product or service that is the subject of a currently displayed advertisement 700, the user then, in the manner disclosed elsewhere herein, defines and transmits an order for that product to product/service vendor website 600, all without disrupting the display of electronic text 1200. If client computer 100 is not then in communication with the global computer network, advertisement 700 may, in one embodiment, cause client computer 100 to connect to global computer network 300 in the background while the user continues to view electronic text 1200 so that upon connection, the order defined by advertisement 700 is then transmitted to product/service vendor website 600.

Alternatively, embodiments of the present invention may be configured so that the order defined by advertisement 700 is stored in system memory 104 until such time as the user initiates communication between client computer 100 and the global compute network. It will be appreciated that a wide variety of other possibilities and configurations may be employed in the context of the present invention and the foregoing embodiments are presented solely by way of example and are not intended to limit in any way the scope of the present invention.

In yet another embodiment, orders transmitted from client computer 100 may be routed first to media vendor website 1000 and subsequently to product/service vendor website 600. Such an arrangement implicates a number of useful features. For example, orders routed in this way would permit the media vendor to accumulate data regarding particular interests of the user and would thus enable the media vendor to direct certain electronic texts and/or advertisements to the user. Such data may be provided to the vendor as well, for example, to serve as a basis for payment of commissions from the product/service vendor to the media vendor. Thus, embodiments of the present invention not only serve to facilitate the ready ordering of goods and services by way of global computer network 300, but also act to generate data which may be employed for a variety of useful commercial purposes.

Directing attention now to FIG. 4C, and with continuing reference to FIGS. 4A and 4B, various details of a process 1300 concerning the use of an advertisement in the context of electronic texts are provided. In one embodiment of process 1300, step 1302 is entered wherein the media vendor creates a library of electronic works. In step 1304, the vendor likewise creates a plurality of advertisements. It will be appreciated that steps 1304 and 1302 may be performed in reverse order without impairing the functionality of the present invention. After generation of electronic works and advertisements, step 1306 of process 1300 is entered and one or more advertisements are embedded and arranged in one or more electronic works in accordance with various predetermined criteria.

Subsequently, a user decides to purchase one of the electronic texts from the media vendor. In this case, step 1308 is entered wherein the selected electronic text(s) is purchased and downloaded from the media vendor website to the client computer of the user. The user is then able to view the downloaded electronic texts by way of the reader software. Upon activating the reader software, the user then enters step 1310, wherein at least a portion of the electronic work, and associated advertisements, are displayed or otherwise presented at the client computer.

In the event the user decides to purchase one or more products or services featured in the displayed advertisements, step 1312 of the process is entered, wherein the user selects one or more appropriate wallet files and uploads appropriate data therefrom to corresponding data form element(s) of the displayed advertisement(s). As is the case with other embodiments of the present invention, it will be appreciated that such data need not originate from the wallet file but may alternatively be entered by the user in a variety of ways including, but not limited to, orally, or by way of an input device such as a mouse or keyboard Step 1314 of the process is then entered where the data received by the advertisement is used to generate a unique order. Once the requisite data has been input to the advertisement, step 1316 of the process is entered wherein the user selects an order action form element and such selection causes step 1318 of the process to be entered where the order is transmitted to the vendor website and processed there.

Finally, step 1320 of the process is entered wherein the product/service vendor website located at the server causes one or more actions to be performed in response to receipt of the order. Preferably, at least one of such actions comprises the sending of an e-mail confirmation message from the product/service vendor website to the client computer indicating that the order has been received, confirming the contents of the order, and indicating, for example, that the order has been submitted for processing. It will be appreciated that process 1300 may be supplemented with various other steps as may be required to suit the vendors, and/or the products and services provided.

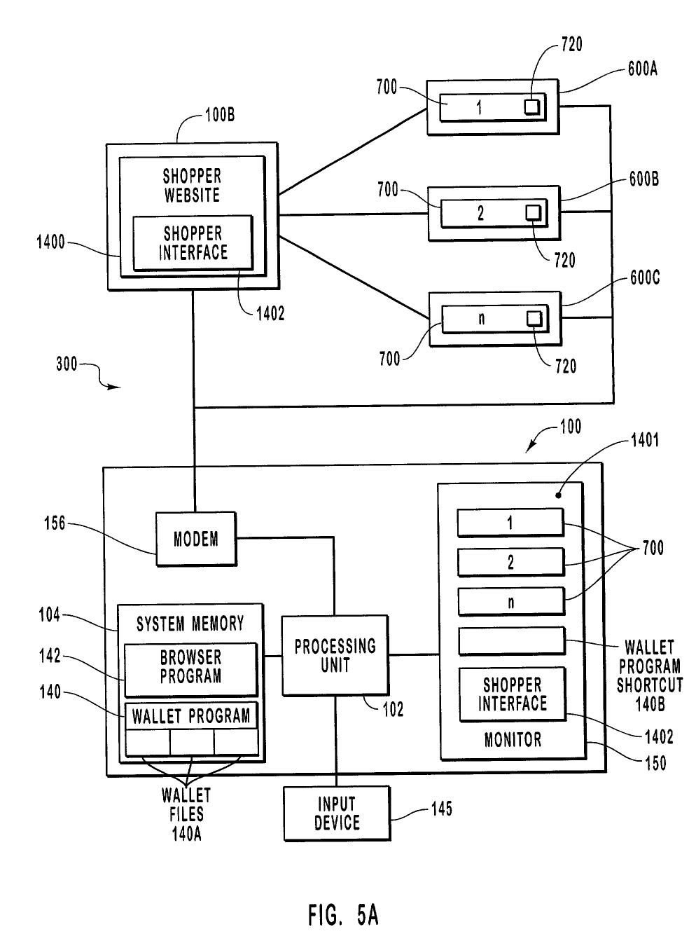

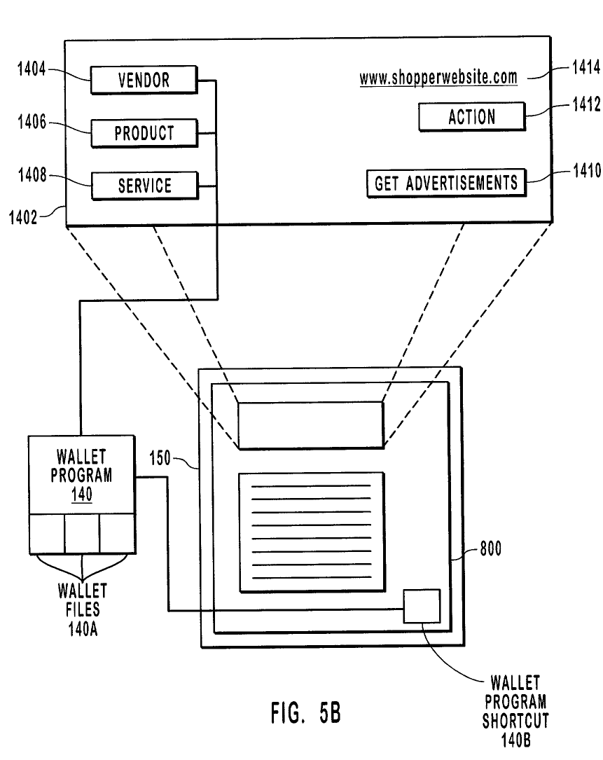

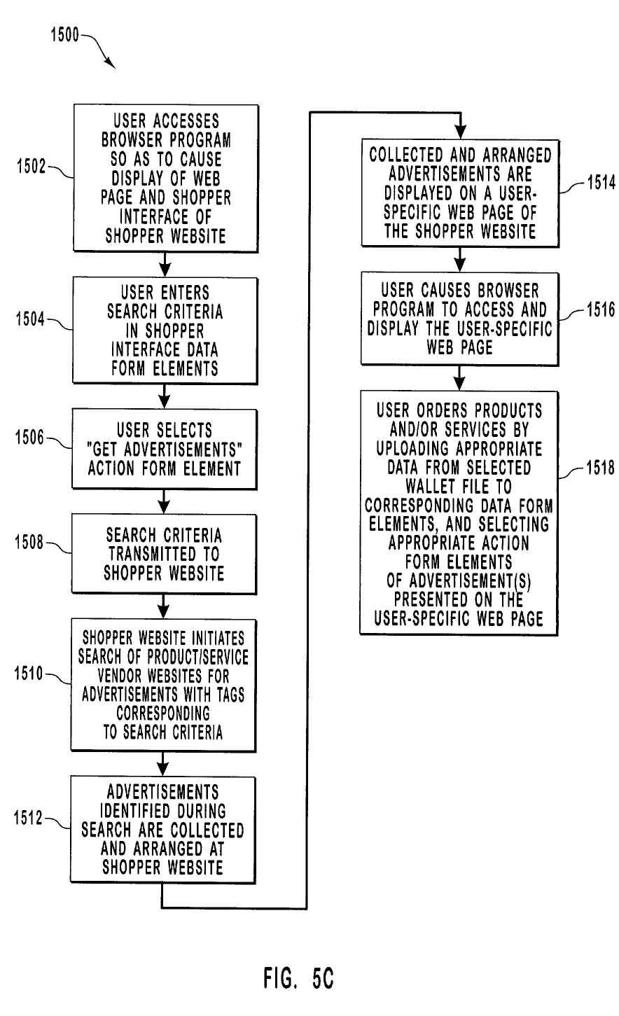

Directing attention now to FIG. 5A, various details are provided regarding embodiments of the user interface employed in the context of a personal shopping service. As indicated in the illustrated embodiment, a client computer 100 is configured for communication over global computer network 300. In particular, client computer 100 is configured for communication with shopper website 1400 and product/service vendor websites 600A, 600B, and 600C, by way of modem 156. Because the afore-mentioned websites all comprise a portion of global computer network 300, it will be appreciated that shopper website 1400 is likewise capable of communication and data exchange with product/service vendor websites 600A, 600B, and 600C.

Each of product/service vendor websites 600A, 600B, and 600C include one or more advertisements 700. Advertisements 700 may, or may not, be related to products and/or services offered for sale through product/service vendor websites 600A, 600B, and 600C. Further, advertisements 700 may appear in non-commercially oriented websites. Preferably, each advertisement 700 includes a tag 720 so that a particular advertisement 700 can be readily identified when encountered by a search engine or other program or software having global computer network search functionality. In one embodiment, tag 720 corresponds to the nature of the information presented in advertisement 700. As various details regarding the features of advertisement 700, as well as the manner in which data may be uploaded or otherwise entered in the data form elements thereof, have been discussed elsewhere herein in the context for other embodiments, no further discussion is required here. However, it should be appreciated that the embodiments of advertisement 700 discussed herein are presented solely by way of example and are not intended to limit the scope of the present invention in anyway. The same is likewise true for embodiments of client computer 100 and the various features and functionalities thereof.

In general, shopper website 1400 includes software, computer code, or the like capable of acting upon input received by shopper interface 1402. Shopper interface 1402 is characterized by, among other things, the functionality and features present in the various other embodiments of user interfaces disclosed herein. Preferably, shopper website 1400 performs, or directs, a search of global computer network 300 to identify various advertisements 700 consistent with criteria specified by a user by way of shopper interface 1402 After the user has entered data into data form elements of shopper 1402 and selected one or more appropriate action form elements, corresponding search criteria are then transmitted to shopper website 1400. It will be appreciated that the services made available by way of shopper website 1400 may be provided, for example, on a subscription basis that would require a user to pay a periodic fee for continued access to such services.

In response, shopper website 1400 searches global computer network 300 for advertisement(s) 700 having tag(s) 720 consistent with the search criteria received by shopper interface 1402. Upon identification of advertisement(s) 700 meeting such search criteria, shopper website 1400 then gathers copies of such advertisements 700, arranges the gathered advertisements 700 in accordance with one or more criteria, and transmits the gathered advertisements 700 to client computer 100 for display on monitor 150 in the context of the display of a web page of shopper website 1400. It will be appreciated that shopper website 1400 may be configured so as to permit a user to have assigned to him a customized, user-specific web page that the user can access to view advertisements 700 collected by shopper website 1400 on his behalf.

Directing attention now to FIG. 5B, and with continuing attention to FIG. 5A, additional details are provided regarding an embodiment of shopper interface 1402. One embodiment of shopper interface 1402 includes a vendor form element 1404, a product form element 1406, and a service form element 1408. By entering data into one or more of the aforementioned form elements, the user is able to establish search criteria corresponding to the products, services, vendors, or other desired variables, in which the user is interested. It will be appreciated that any of a variety of data form elements may be used in conjunction with shopper interface 1402 and that the data form elements indicated in the illustrated embodiment are provided solely by way of example. As in the case of other embodiments of the present invention, wallet program 140 may be used to create one or more wallet files 140A containing data of a type and format appropriate for entry in data form elements 1404 through 1408.

Further, shopper interface 1402 additionally includes various action form elements, for example, a “GET ADVERTISEMENTS” form element 1410 and additional action form element 1412. It will be appreciated that, depending upon the application, various other or additional action form elements may be employed in the context of shopper interface 1402. Finally, shopper interface 1402 preferably includes a hyperlink 1414 configured so that selection of hyperlink 1414 will cause browser program 142 (not shown) to access and display one or more web pages of shopper website 1400 on monitor 150.

Turning now to FIG. 5C, various details are provided regarding an embodiment of a process, denoted at 1500, for employment of the embodiment of advertisement 700 indicated in FIGS. 5A and 5B. The user initiates process 1500 by entering step 1502 wherein the user causes a browser program to display the web page and shopper interface of the shopper website. In step 1504, the user enters various desired search criteria in one or more data form elements of the shopper interface. After the user is satisfied that the search criteria are appropriate, the user enters step 1506 by selecting the “GET ADVERTISEMENTS” action form element of the shopper interface. Selection of the aforementioned action form element causes the process to enter step 1508 wherein the search criteria identified by the user are transmitted to the shopper website. In response, step 1510 is entered wherein the shopper website initiates a search of product/service vendor websites for advertisements with tags corresponding to search criteria identified by the user.

In step 1512 of process 1500, advertisements consistent with the search criteria identified by the user are identified and then collected and arranged at the shopper website. Subsequently, step 1514 is entered wherein the collected and arranged advertisements are displayed, preferably on a user-specific web page of the shopper website. At his option, the user may enter step 1516 wherein the browser program is caused to access and display the user-specific web page and the collected advertisements. The user may then enter step 1518 and order products and/or services, in the manner disclosed herein, by uploading appropriate data from a wallet file to corresponding data form elements, and selecting appropriate action form elements, of the advertisements presented on the user-specific web page. Finally, it will be appreciated that process 1500 may include a variety of other steps in addition to those specifically illustrated in FIG. 5C.

For example, process 1500 may include a step wherein once advertisements have been identified, collected, and arranged at the collecting website, the shopper website may send an e-mail or other communication to the user indicating that the advertisements have been located and are available for access by the user. As another example, the process may include a step wherein searches, based upon criteria input by the user, are conducted according to the regular intervals specified by the user. In this way, the user has access to continuously updated advertisements. The aforementioned is a useful feature in instances where, for example, the pricing, availability, and the like of one or more desired products or services is likely to vary over time.

In yet another embodiment, the user may establish a plurality of groups of search criteria so as to facilitate the identification of advertisements consistent with a variety of different products and services. Each group of search criteria would be stored at the shopper website and would be accessible by the user by way of the user-specific web page of the collecting website. In this way, the user need only specify search criteria for a particular product or service a single time. Then, when the user wants to conduct a particular search, the user can simply select from a menu one or more groups of search criteria previously entered by the user. The search, or searches, would then be conducted by the collecting website consistent with the group(s) of search criteria input by the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by the United States Letters Patent is:

1. In a client-server environment including at least one server and first and second client computers configured for communication with each other and with the server, and at least the first client computer including a display and an input device, a method of creating and employing a user interface for facilitating communication between at least the first client computer and the server, the method comprising:
(a) creating the user interface by constructing an interface structure and embedding display material, a server communication link, a plurality of data form elements and at least one action form element in said interface structure;
(b) presenting, on the display of the first client computer, said display material of said interface structure;
(c) uploading data from the first client computer to the user interface, by way of the input device, so that at least two of said plurality of data form elements are populated substantially simultaneously with respective portions of said uploaded data; and
(d) uploading instructions from the first client computer to the server in response to receipt, at the user interface, of an action form element selection signal indicative of the input device providing input to said at least one action form element, said uploading of instructions being facilitated by said server communication link, and said instructions corresponding to data entered in said plurality of data form elements.

2. The method as recited in claim 1, further comprising downloading the user interface from the server to the first client computer.

3. The method as recited in claim 2, further comprising retaining a copy of the user interface at the server.

4. The method as recited in claim 1, further comprising downloading the user interface from the second client computer to the first client computer.

5. The method as recited in claim 4, further comprising storing the downloaded user interface at said first client computer.

6. The method as recited in claim 1, further comprising performing, by the server, at least one action consistent with said instructions.

7. The method as recited in claim 1, further comprising receiving, at the user interface, a data form element selection signal indicative of the input device entering data in said plurality of data form elements.

8. The method as recited in claim 1, further comprising processing, at the server, at least some of said data entered in said plurality of data form elements.

9. The method as recited in claim 1, further comprising embedding the user interface in a web page so that when said web page is presented on the display, said display material of the user interface is presented on the display substantially contemporaneously with said web page.

10. The method as recited in claim 1, further comprising embedding the user interface in an electronic text so that when a portion of said electronic text is presented on the display, said display material of the user interface is presented on the display substantially contemporaneously with said portion of electronic text.

11. The method as recited in claim 10, wherein the user interface is replaced by another user interface upon occurrence of a predetermined event.

12. The method as recited in claim 11, wherein said predetermined event comprises turning of a page of said electronic text.

13. The method as recited in claim 1, further comprising transmitting feedback from the server to the first client computer.

14. The method as recited in claim 1, wherein said display material embedded in said interface structure is selected from the group consisting of: audio material, video material, audio/video material, textual material, and graphical material.

15. The method as recited in claim 1, wherein said plurality of data form elements comprises at least two empty data fields.

16. The method as recited in claim 15, wherein said plurality of data form elements further comprises a pull-down menu.

17. The method as recited in claim 1, further comprising embedding in said interface structure a hyperlink to a desired web page.

18. In a client-server environment including a server configured for communication with a client computer, the client computer including a memory, a display and an input device, a method of populating a web page order form having a plurality of data form elements presented on the display, the method comprising:
(a) creating, with a wallet program, at least one wallet file resident in the memory of the client computer, said at least one wallet file containing at least one predefined data set;
(b) presenting on the display of the client computer a graphical representation of said at least one wallet file; and
(c) uploading, from said at least one predefined data set, data to the web page order form so that at least two of the plurality of data form elements are populated substantially simultaneously with corresponding data from said at least one predefined data set.

19. The method as recited in claim 18, wherein said data in said at least one predefined data set comprises consumer information.

20. The method as recited in claim 19, wherein said consumer information comprises at least two elements selected from the group consisting of: consumer name, consumer address, consumer credit card number, credit card expiration date, consumer debit card number, consumer debit card expiration date, and email address.

21. The method as recited in claim 18, wherein said data uploaded to the web page order form comprises less than all data contained in said at least one predefined data set.

22. The method as recited in claim 21, further comprising the steps of searching said at least one predefined data set and extracting said data for uploading, said searching and extracting being performed by the wallet program.

23. The method as recited in claim 21, wherein said extracted data is consistent with data types specified by the web page order form.

24. The method as recited in claim 23, wherein said step of uploading comprises dragging and dropping, with the input device, said graphical representation of said at least one wallet file onto the web page order form.

25. The method as recited in claim 18, further comprising the step of translating, with said wallet program, said data into a predetermined format prior to said step of uploading said data.

26. The method as recited in claim 18, wherein at least some of said data stored in said at least one predefined data set is in a format compatible with the web page order form.

27. The method as recited in claim 18, further comprising transmitting feedback from the web page order form when said uploaded data is incompatible with a least one of the data form elements.

28. In a client-server environment including a product/service vendor server configured for communication with a client computer, a method of advertising and taking product and service orders, comprising:
(a) making available to the client computer an advertisement including commercial information, a plurality of data form elements, and an action form element;
(b) receiving, at the advertisement, data from the client computer so that at least two of said plurality of data form elements are populated substantially simultaneously with respective portions of said data;
(c) receiving, at the advertisement, a data form element selection signal indicating that data has been entered into said plurality of data form elements; and
(d) defining an order corresponding to said data received.

29. The method of claim 28, further comprising embedding the advertisement in a web page available to the client computer.

30. The method of claim 28, further comprising embedding the advertisement in an electronic text available to the client computer.

31. The method of claim 28, further comprising receiving, at the advertisement, an action form element selection signal indicative of the input device providing input to said action form element.

32. The method of claim 31, further comprising transmitting feedback from the server to the client computer when said action form element selection signal is inconsistent with said data entered into said plurality of data form elements.

33. The method of claim 28, further comprising receiving said order at the product/service vendor server.

34. The method as recited in claim 28, wherein said at least two of said plurality of data form elements are populated while the client computer is off-line.

35. In a client-server environment including at least one server and first and second client computers configured for communication with each other and with the server, at least one of the client computers including a display and an input device, a method of creating and using an advertisement for facilitating advertising and ordering of goods and services, the method comprising:
(a) creating the advertisement by constructing an interface structure and embedding display material, a server communication link, a plurality of data form elements, and at least one action form element in said interface structure;
(b) presenting, on the display of the first client computer, said display material of the advertisement;
(c) uploading data, from a predefined data set of a wallet file resident on the client computer and created by a wallet program, to said advertisement, by way of the input device, so that at least two of said plurality of data form elements are populated substantially simultaneously with corresponding data from said predefined data set, said uploaded data defining an order;
(d) receiving, at the advertisement, at least one data form element selection signal indicative of the input device entering data in said plurality of data form elements;
(e) receiving, at the advertisement, an action form element selection signal indicative of the selection device providing input to said action form element; and
(f) uploading said order from the client computer to the server in response to receipt of said action form element selection signal, said uploading being facilitated by said server communication link.

36. The method of claim 35, further comprising downloading said advertisement from the server to the first client computer.

37. The method of claim 35, wherein said display material comprises commercial information.

38. The method of claim 35, further comprising performing, by the server, at least one action in response to receipt of said order.

39. The method as recited in claim 35, further comprising embedding said advertisement in a web page so that when said web page is presented on the display, said display material is presented on the display substantially contemporaneously with said web page.

40. The method as recited in claim 35, further comprising embedding said advertisement in an electronic text so that when a portion of said electronic text is presented on the display, said display material is presented on the display substantially contemporaneously with said portion of said electronic text.

41. The method as recited in claim 35, where said advertisement is downloaded from the second client computer to the first client computer.

42. The method as recited in claim 35, wherein said data uploaded to the advertisement comprises less than all data contained in said predefined data set.

43. The method as recited in claim 42, further comprising searching said predefined data set and extracting said data for uploading, said searching and said extracting being performed by said wallet program.

44. In a client-server environment including a server configured for communication with a client computer, the client computer including a memory, a display and an input device, a computer program product for implementing a method of populating a user interface having a plurality of data form elements presented on the display, comprising:
a computer readable medium carrying computer executable instructions for performing the method, wherein the method comprises:
(a) creating, with a wallet program, at least one wallet file resident in the memory of the client computer, said at least one wallet file including at least one predefined data set;
(b) presenting on the display a graphical representation of said at least one wallet file; and
(c) uploading, from said at least one data set, data to the user interface so that at least two of the plurality of data form elements are populated substantially simultaneously with corresponding data from said at least one predefined data set.

45. The computer program product as recited in claim 44, wherein said data uploaded to the user interface comprises less than all data contained in said at least one predefined data set.

46. The computer program product as recited in claim 44, further comprising searching said at least one predefined data set and extracting said data for uploading, said searching and said extracting being performed by said wallet program.

47. The computer program product as recited in claim 44, wherein said step of uploading comprises dragging and dropping, with the input device, said graphical representation of said at least one wallet file onto the user interface.

48. The computer program product as recited in claim 44, further comprising translating, with said wallet program, at least some of said selected data into a predetermined format prior to said uploading of said selected data.

49. The computer program product as recited in claim 44, wherein said data stored in said at least one predefined data set is of a format compatible with the user interface.

50. The computer program product as recited in claim 44, wherein the at least two of the plurality of data form elements are populated while the client computer is offline.

51. In a client-server environment including a product/service vendor server configured for communication with a client computer, a computer program product for implementing a method of advertising and taking product and service orders, comprising:
a computer readable medium carrying computer executable instructions for performing the method, wherein the method comprises:
(a) making available to the client computer an advertisement including commercial information, a plurality of data form elements, a server communication link, and an action form element;
(b) receiving, at the advertisement, data from the client computer so that at least two of said plurality of data form elements are populated substantially simultaneously with corresponding data;
(c) receiving, at the advertisement, a data form element selection signal indicating that data has been entered into said plurality of data form elements; and
(d) defining an order corresponding to said data received.

52. The computer program product of claim 51, further comprising embedding the advertisement in a web page available to the client computer.

53. The computer program product of claim 51, further comprising embedding the advertisement in an electronic text available to the client computer.

54. The method as recited in claim 53, wherein the user interface is replaced by another user interface upon occurrence of a predetermined event.

55. The method as recited in claim 54, wherein said predetermined event comprises turning of a page of said electronic text.

56. The computer program product of claim 51, further comprising receiving said order at the product/service vendor server.

57. The computer program product of claim 51, further comprising receiving at the server, by way of said server communication link, said order.

58. The method of claim 57, further comprising performing, by the server, at least one action consistent with said order.

59. The method of claim 51, further comprising receiving, at the advertisement, an action form element selection signal indicative of the input device providing input to said action form element.

60. In a global computer network environment including a server having a shopper website and a plurality of product/service vendor websites capable of communication with a client computer having a display and an input device, a method for implementing a shopping service, the method comprising:
(a) creating a user interface by constructing an interface structure and embedding a data form element, an action form element, and display material in said interface structure;
(b) making said user interface available to the client computer;
(c) receiving data from the client computer at said user interface; and
(d) receiving at said action form element a request to search the global computer network for advertisements corresponding to said data received at said user interface;
(e) searching the global computer network for said advertisements and identifying advertisements consistent with said data;
(f) making said identified advertisements available to the client computer;
(g) receiving, from the client computer, data at least one of said identified advertisements so that at least two data form elements of said at least one identified advertisement are populated substantially simultaneously;
(h) receiving at said selected identified advertisement a data form element selection signal indicative of receipt of data from the client computer, said data defining an order, and
(i) receiving said order at the server.
